(19) United States
(12) Patent Application Publication
(10) Pub. No.: US 2003/0058118 A1
(43) Pub. Date: Mar. 27, 2003

(54) Vehicle and vehicle tire monitoring system, apparatus and method

(76) Inventor: Kitchener C. Wilson, Santa Barbara, CA (US)

Correspondence Address: Louis A. Mok, KOPPEL, JACOBS, PATRICK & HEYBL, 555 St. Charles Drive, Suite 107, Thousand Oaks, CA, 91360, US

(21) Appl. No.: 10/143,312

(22) Filed: May 10, 2002

Related U.S. Application Data
(60) Provisional application No. 60/290,672, filed on May 15, 2001.
(60) Provisional application No. 60/307,956, filed on Jul. 25, 2001.
(60) Provisional application No. 60/324,204, filed on Sep. 21, 2001.

(51) Int. Cl. G08B 21/00

(52) U.S. Cl. 340/679; 340/683; 340/443; 340/442

(57) ABSTRACT

Vehicle and vehicle tire monitoring system, apparatus and method determine the load-induced deflection or deformation of a vehicle tire and based thereon, deflection-related information, such as tire load, molar air content, total vehicle mass and distribution of vehicle mass, may be provided. The tire deflection region or contact region of the loaded tire is detected by sensing the acceleration of the rotating tire by means of an accelerometer mounted on the tire, preferably on an inner surface such as the tread lining thereof. As the tire rotates and the accelerometer is off of the contact region, a high centrifugal acceleration is sensed. Conversely, when the accelerometer is on the contact region and not rotating, a low acceleration is sensed. The deflection points delimiting the contact region are determined at the points where the sensed acceleration transitions between the high and low values.

### CROSS REFERENCES TO RELATED APPLICATIONS

The benefit of U.S. Provisional Application Serial Nos. 60/290,672 filed May 15, 2001; 60/307,956 filed Jul. 25, 2001; and 60/324,204 filed Sep. 21, 2001 is hereby claimed and these provisional applications are incorporated herein by reference in their entireties.

### BACKGROUND OF THE INVENTION

1. Field of the Invention

The present invention relates generally to vehicles and vehicle tires. More particularly, the present invention relates, among other things, to systems, apparatus and methods for monitoring, in real time, the load-induced deflection of a vehicle tire and providing deflection-related information such as tire load.

2. Description of the Prior Art

The combined Ford Explorer and Firestone tire failures generated a great deal of interest in monitoring tires and in vehicle stability. The U.S. automobile industry and Congress moved to provide and to require real-time on-vehicle monitoring of tire pressure to detect mis-inflated tires (TREAD Act of Nov. 1, 2000), and the new vehicle control systems include stability enhancement systems. Tire pressure is a convenient measurement to make and is the standard by which tires are monitored. Tire load, that is, the supported weight, is a more difficult measurement but, unlike pressure, is a direct measure of tire stress.

Tires are selected for a particular vehicle based on the physical strength of the material and on the anticipated normal range of vehicle weight that they must support at specified nominal temperature and pressure. If the vehicle applies a load to a tire in excess of the tire designed load range, the tire is subjected to excessive stress and may fail or have its expected lifetime shortened. Pressure and temperature do not change as a function of load in a manner that is useful for load monitoring. The U.S. National Highway Traffic Safety Administration (NHTSA) includes tire over-loading as one of the factors contributing to the Firestone tire failures. They state that overloading can result in tire failure.

Although the maximum load a tire is designed to support is embossed onto its sidewall, and the vehicle operator is warned not to exceed this rating, there is currently no means available to measure the load and verify safe operation. The NHTSA has further stated that it is generally difficult for the consumer to know the actual load on a tire and its relationship to proper tire inflation.

The shape the loaded tire deforms to under load is also important to its internal stress. NHTSA states a significantly under-inflated tire has its sidewalls flexing more, causing its temperature to increase, and make the tire more prone to failure. According to the Rubber Manufacturers Association, the basis of the industry standard load and pressure relationship is the shape of the loaded tire and, specifically, the angle it deflects through when going from round to flat at the road contact surface. The greater this deflection angle, the more the tire is flattened, the more the rubber tread is flexed, and the more mechanical energy and heat is generated by the flexing. Excessive heat contributes to the failure of the tire structure by:

increased chemical aging that lowers the cohesive strength of the tire allowing crack generation between the layers of its structure;

increased rate of crack propagation with increasing temperature.

Basically, as the tire becomes under-inflated, it flexes more, self-heats, cracks form, and the cracks propagate until the tire falls apart. The industry standard load-pressure relationship is based on correcting an overload (over-deflection) by increasing pressure up to the tire pressure limit in order to reduce the deflection bending angle and reduce self-heating.

Tire maintenance is based on the vehicle operator maintaining tire pressure near a nominal value defined by the vehicle and tire manufacturers. Although it is well known by the tire industry that the requisite pressure is dependent on the supported load, this load-dependent pressure information is not provided to the operator since real-time load is unknown. As a result, should the load vary from that assumed by the manufacturer, the tires are improperly inflated. Since the requisite pressure increases with load, the only option left is to assume the maximum load and specify a pressure accordingly. This maximum pressure can 1) give a very hard ride, 2) minimize the tire-to-road contact area available for braking, and 3) wear out the center of the tire tread prematurely. Tire load information is needed to properly inflate tires.

Further, the vehicle mass can be calculated given the load on each tire. Vehicle mass varies according to the payload and is an important parameter for optimizing the performance of the vehicle control system (engine, suspension, brakes, transmission, steering) and for diagnostic/prognostic evaluations of the same.

The distribution of mass can also be calculated given the load on each tire. An improperly balanced vehicle can more easily lose control, as illustrated by various passenger minivans found to become unstable as more passengers were added and the center-of-mass shifted upward and toward the rear. The NHTSA rates vehicles according to their rollover propensity by considering their 3-dimensional center-of-gravity, a measure of the distribution of mass. Because the distribution of mass defines the effective point of application of external forces on the vehicle, knowledge of the distribution of mass is needed to properly adapt the control system for vehicle safety and stability.

Deviations from the nominal pressure are caused by changes in tire air temperature, leaks, and improper inflation. The relationship between temperature and pressure is important to consider. Even though the amount of air in the tire is unchanged, the Ideal Gas Law states that a tire, initially inflated to 30 psi with 70° F. air, will read only 24 psi on a cold −40° F. winter morning and as much as 33 psi when heated to 120° F. on a hot summer road. Given this normal pressure range, a pressure-based tire inflation warning system can false alarm. Rather than using pressure to warn the operator of improper tire inflation, the molar quantity of air in a tire, calculated based on tire volume-temperature-pressure, is a quantity that changes only if air is physically exchanged. Molar calculations automatically compensate for temperature variations and are a more constant determination of tire inflation.

Tire load is directly connected to the molar content and tire pressure and temperature through the tire volume, and all come together to be certain the tires are not over-stressed and are properly inflated and that the vehicle is stable.

This tire and vehicle information is important within the vehicle, but also important remotely from it. As the telematic capability of vehicles increases, they are more capable of wirelessly communicating with a remote facility for monitoring the vehicle health (diagnostics), for prediction of maintenance (prognostics), and to monitor the vehicle as it passes on the road. The information is also historically important to understand the cause of accidents. Accident reconstruction is based on the physics of vehicle motion and, unless the state of the tires and the mass and its distribution is known, is only an educated rough estimate.

FIG. 1 shows a vehicle wheel 10 of conventional design comprising a tire 12 mounted on a wheel rim 14. The tire has an unloaded outer radius R and includes an inner lining surface 15 having an unloaded radius r. The tire 12 is shown in a loaded condition; as is well known, a loaded tire is not round as the load causes a region 16 in contact with the road to deflect and flatten along a contact length 18. Within the flattened contact region 16, the inner lining surface 15 has a deflation height 19 relative to the unloaded inner tire surface radius r. The load is supported on the flattened contact region 16 according to the area of the region 16 and the pressure within the tire. Tire air pressure can be measured and, since the width of the contact area is essentially fixed and equal to the known tread width of the tire, the area of the contact region 16 can be determined if the length 18 is known. The contact region length 18 is the distance between two deflection points 20 and 22 that define the beginning and the end of the contact region 16. A deflection angle 24 is defined between a tangent 26 to the fully inflated (unloaded) tire at the deflection point and the plane 28 of the contact region 16.

Efforts to detect the deflection points delimiting the deflection contact region of a loaded tire have been based on detecting the occurrence of a phenomenon associated uniquely with the deflection points in order to identify the greater physical bending of the tire as it comes into contact with the road. For example, U.S. Pat. No. 5,749,984 to Frey, et al., and U.S. Pat. No. 5,877,679 to Prottey suggest placing delicate sensors (for example, a piezoelectric polymer or a force sensitive resistor) directly onto an inner surface of the tire. However, the disclosed sensors are thereby exposed to temperature and stress levels that may impair their useful lives.

U.S. Pat. Nos. 5,573,610 and 5,573,611 to Koch, et al., and U.S. Pat. No. 6,208,244 to Wilson, et al., each discloses the use of a patch to attach a monitoring device to the lining of a tire. The patch fully encloses the monitoring device and holds it rigidly against the lining with small holes for extending a radio antenna. Since the hottest part of a tire is its tread, where it contacts and works against the pavement, these arrangements tend to capture the heat from this source and concentrate it onto the temperature sensitive electronic components of the monitoring device. Furthermore, the patches used must be specially designed with a dome shape to provide a space for housing the monitoring device.

U.S. Pat. No. 4,364,267 to Love, Jr., et al., discloses a method and an apparatus for correlating tire inflation pressure and tire load using the tire footprint length on a tire contact gauge for a static, that is, nonmoving, vehicle. Among other things, Love, Jr., et al., do not provide such a correlation for a moving vehicle, let alone in real time, and they do not consider the effects of sidewall forces.

### SUMMARY OF THE INVENTION

In accordance with one specific, exemplary embodiment of the invention, there is provided a device for determining the occurrences of deflections of a vehicle tire due to a load while rotating upon a load-bearing surface, the device comprising an accelerometer, adapted to be mounted on the tire, for sensing acceleration variations due to load-induced tire deflections and providing an output representative of said acceleration variations; and an electrical circuit responsive to said output to provide signals representative of the occurrences of said deflections.

In accordance with another specific, exemplary embodiment of the invention, there is provided in a vehicle wheel comprising a tire mounted on a wheel rim, the tire having known geometric parameters, the tire and rim defining a cavity for retaining air under pressure, an apparatus within said cavity for monitoring the load-induced deformation imposed on the tire during rotation thereof on a load-bearing surface, said apparatus comprising, first, a device attached to the tire for determining the occurrences of deflections of the tire due to a load on the tire while rotating upon the load bearing surface, the device comprising (1) an accelerometer disposed to sense acceleration variations due to load-induced tire deflections and being adapted to provide an output representative of said acceleration variations; (2) an electrical circuit responsive to said accelerometer output to provide signals representative of the occurrences of said tire deflections; and (3) a transmitter coupled to said electrical circuit and adapted to transmit signals representative of said tire deflection signals; and, second, a receiver positioned to receive said signals transmitted by said transmitter.

Further pursuant to the present invention, there is provided in a vehicle wheel comprising a tire mounted on a wheel rim, the tire and rim defining a cavity for retaining air under pressure, an apparatus for monitoring the load imposed on the tire during rotation thereof on a load-bearing surface, said apparatus comprising an accelerometer disposed to sense acceleration variations due to load induced tire deflections and for providing an output representative of said acceleration variations; a first electrical circuit responsive to said accelerometer output to provide signals representative of the occurrences of said tire deflections; a pressure sensor disposed to sense the pressure of the air within the cavity and provide an output representative of said pressure; a second electrical circuit responsive to said pressure sensor output to provide signals representative of said air pressure; and a transmitter coupled to said first and second electrical circuits and adapted to transmit signals representative of said tire deflection and pressure signals.

In accordance with yet another embodiment of the present invention, there is provided in a vehicle wheel comprising a tire mounted on a wheel rim, the tire and rim defining a cavity for retaining air under pressure, an apparatus for monitoring the molar quantity of air within the tire during rotation thereof on a load-bearing surface, said apparatus comprising an accelerometer disposed to sense acceleration variations due to load induced tire deflections and for providing an output representative of said acceleration variations; a first electrical circuit responsive to said accelerometer output to provide signals representative of the occurrences of said tire deflections; a pressure sensor disposed to sense the pressure of the air within the cavity and to provide an output representative of said pressure; a second electrical circuit responsive to said pressure sensor output to provide signals representative of said air pressure; a temperature sensor disposed to sense the temperature of the air within the cavity and to provide an output representative of said temperature; a third electrical circuit responsive to said temperature sensor output to provide signals representative of said air temperature; and a transmitter coupled to said first, second and third electrical circuits and adapted to transmit signals representative of said tire deflection and air pressure and temperature signals.

Pursuant to another specific aspect of the invention, there is provided a method for determining the occurrence of a deflection of a vehicle tire due to a load on the tire while rotating on a load bearing surface, the method comprising the steps of sensing acceleration in a local region of the tire; detecting an acceleration variation caused by the load induced deflection of the tire; and generating a signal in response to the detected acceleration variation, said signal indicating the occurrence of the deflection.

Still further, there is provided a method for determining the occurrence of a deflection of a vehicle tire due to a load on the tire while rotating on a load bearing surface comprising the steps of sensing acceleration in a local region of the tire; generating a first signal representative of the sensed acceleration; comparing the first signal with a second signal representative of a reference acceleration; and generating a third signal indicating the occurrence of the deflection in response to the comparison of the first and second signals.

In accordance with still another specific, exemplary embodiment of the present invention, there is provided a method for determining the deformation of a loaded vehicle tire mounted on a rim, the tire having a contact region between the tire and a load-bearing surface, the contact region being delimited by a leading edge and a trailing edge, the tire having known geometric parameters, the tire and rim defining an interior tire cavity, the method comprising the steps of sensing acceleration in a local region of the tire; detecting the occurrences of a first acceleration variation and a second acceleration variation occurring, respectively, at said leading and trailing edges of the contact region; determining the elapsed time between the occurrences of said first and second acceleration variations; determining the rotational period of the tire based on the time between the occurrences of sequential acceleration variations at said leading edge or at said trailing edge; and computing the tire deformation based on the ratio of said elapsed time to said rotational period and the known geometric parameters of the tire.

In accordance with yet another embodiment, a method is provided for determining the molar air content of a loaded vehicle tire mounted on a rim, the tire having a contact region between the tire and a load-bearing surface, the contact region being delimited by a leading edge and a trailing edge, the tire having known geometric parameters, the tire and rim defining an interior tire cavity, the method comprising the steps of measuring the pressure and the temperature of the air within the tire cavity; generating signals representative of said measured air pressure and temperature; sensing acceleration in a local region of the tire; detecting the occurrences of a first acceleration variation and a second acceleration variation occurring, respectively, at said leading and trailing edges of the contact region; determining the elapsed time between the occurrences of said first and second acceleration variations and generating a signal representative of said elapsed time; determining the rotational period of the tire based on the time between the occurrences of sequential acceleration variations at said leading edge or at said trailing edge; and computing the molar air content of the loaded tire based on said signals and the known geometric parameters of the tire.

In accordance with embodiment of the invention, there is provided a method for determining the total mass and mass distribution of a vehicle supported by a plurality of wheels, each of the wheels comprising a tire mounted on a rim, the tire and rim of each wheel defining an interior tire cavity, each tire having a contact region between the tire and a load-bearing surface, the contact region being delimited by a leading edge and a trailing edge, each tire having known geometric parameters, said method comprising the steps of, first, for each tire, (1) measuring the pressure of the air within the tire cavity; (2) generating a signal representative of said measured air pressure; (3) sensing acceleration in a local region of the tire; (4) detecting the occurrences of a first acceleration variation and a second acceleration variation occurring, respectively, at said leading and trailing edges of the contact region; (5) determining the elapsed time between the occurrences of said first and second acceleration variations and generating a signal representative of said elapsed time; and (6) determining the rotational period of the tire based on the time between the occurrences of sequential acceleration variations at said leading edge or at said trailing edge; and, second, computing the total mass of the vehicle based on said signals from each of the plurality of tires and their known geometric parameters.

In accordance with a further aspect of the present invention, there is provided a system for monitoring in real time the load-induced deflection on at least one tire supporting a vehicle and for providing deflection-related information, the at least one tire being mounted on a rim and defining with said rim an interior tire cavity, the at least one tire having a contact region between the at least one tire and a load-bearing surface, the at least one tire having known parameter values, the at least one tire having an on-contact time and a rotational period, said system comprising an accelerometer disposed within the at least one tire to sense acceleration variations due to load induced tire deflections and for providing an output representative of said acceleration variations; an electrical circuit responsive to said accelerometer output for producing signals from which the ratio of the on-contact time to the rotational period of the at least one tire may be determined; a transmitter mounted within the tire cavity responsive to said ratio-determining signals, for transmitting a signal representative thereof to a location within said vehicle remote from the at least one tire; a receiver within the vehicle remote from the at least one tire for receiving said signals transmitted by the transmitter mounted within the tire cavity; a memory for storing known values comprising parameter values of the at least one tire; and a computer connected to said receiver and memory for computing said deflection-related information based on said transmitted signal and said known tire parameter values.

### BRIEF DESCRIPTION OF THE DRAWINGS

Further objects, features and advantages of the present invention will become evident from the detailed description of the preferred embodiments, below, when read in conjunction with the accompanying drawings in which:

FIG. 1 is a schematic, side elevation view, of a vehicle wheel of conventional design shown in a loaded condition with a deflection region;

FIG. 2 is a block diagram of a system in accordance with a preferred embodiment of one aspect of the present invention;

FIG. 3 is a schematic, side elevation view, of a loaded vehicle wheel in accordance with a preferred embodiment of another aspect of the invention, and shows two accelerometer orientations that may be used in the practice of the invention;

FIG. 4 is a plot of radial acceleration vs. vehicle speed for a typical passenger vehicle tire;

FIG. 5 is a graphical representation of the general shape of an acceleration vs. time output signal generated by an accelerometer mounted on a vehicle tire in accordance with the present invention;

FIG. 6A is a graphical representation of an actual acceleration vs. time signal generated by a radial accelerometer mounted on a vehicle tire in accordance with the present invention;

FIG. 6B is a plot of the signal of FIG. 6A processed by a low-pass filter;

FIG. 6C is a plot of the signal of FIG. 6B after having been passed through a threshold detector;

FIG. 7 is a plot showing the effect of gravity on the signal generated by a radial accelerometer in accordance with the invention;

FIG. 8 is a schematic representation of a vehicle tire showing the various positions of a tangential accelerometer in accordance with the invention during rotation of the tire;

FIG. 9 is a plot showing the effect of gravity on the signal generated by a tangential accelerometer in accordance with the invention;

FIG. 10 is a schematic diagram of a contact acceleration threshold detector circuit that may be utilized in connection with the present invention;

FIG. 11 is a partial cross section of a vehicle wheel showing in schematic form a contact region detector mounted within the tire of the wheel and a receiver-transmitter mounted on the valve stem, in accordance with a preferred embodiment of an apparatus comprising yet another aspect of the present invention;

FIG. 12 is an exploded, perspective view of the contact region detector shown in FIG. 11;

FIG. 13 is a cross section view of a portion of a vehicle tire showing an alternative technique for mounting a contact region detector in accordance with the invention;

FIG. 14 is a block diagram of the preferred format of the digital data transmitted from a contact region detector to a receiver-transmitter mounted within a tire, in accordance with the present invention;

FIG. 15 is a block diagram of a contact region detector in accordance with a preferred embodiment of the present invention;

FIG. 16 is a circuit schematic of the contact region detector of FIG. 15;

FIGS. 17A and 17B together comprise a diagram of the logic of the contact region detector of FIGS. 15 and 16;

FIG. 18 is a schematic, side elevation view, in cross section, of a loaded vehicle wheel incorporating a contact region detector and an associated receiver-transmitter in accordance with the invention, illustrating the misalignments of the optical paths between the detector and the receiver-transmitter when the detector is on the contact region of the tire;

FIG. 19 is an axial cross section view of a portion of a vehicle tire showing mounted on an inner tread lining thereof a contact region detector in accordance with an alternative embodiment of the present invention;

FIG. 20 is a cross section of the portion of the vehicle tire shown in FIG. 19 as seen along the line 20-20 in FIG. 19;

FIG. 21 is a cross section of a portion of a vehicle tire showing mounted on an inner tread lining thereof a “tangential” contact region detector pursuant to the invention;

FIG. 22 is a block diagram of a wheel-mounted receiver-transmitter in accordance with a preferred embodiment of the invention;

FIG. 23 is a block diagram of the preferred format of the digital data transmitted from a receiver-transmitter mounted within a vehicle wheel to a receiver, remote from the wheel, carried by the vehicle;

FIG. 24 is a block diagram of a vehicle receiver in accordance with a preferred embodiment of the invention;

FIG. 25 is a schematic, side elevation view of a vehicle wheel illustrating the deflation volume of the tire when loaded;

FIG. 26 is a diagrammatic representation of the forces on and the dimensions of a moving, loaded vehicle; and

FIG. 27 is a schematic representation of an operator status and warning display.

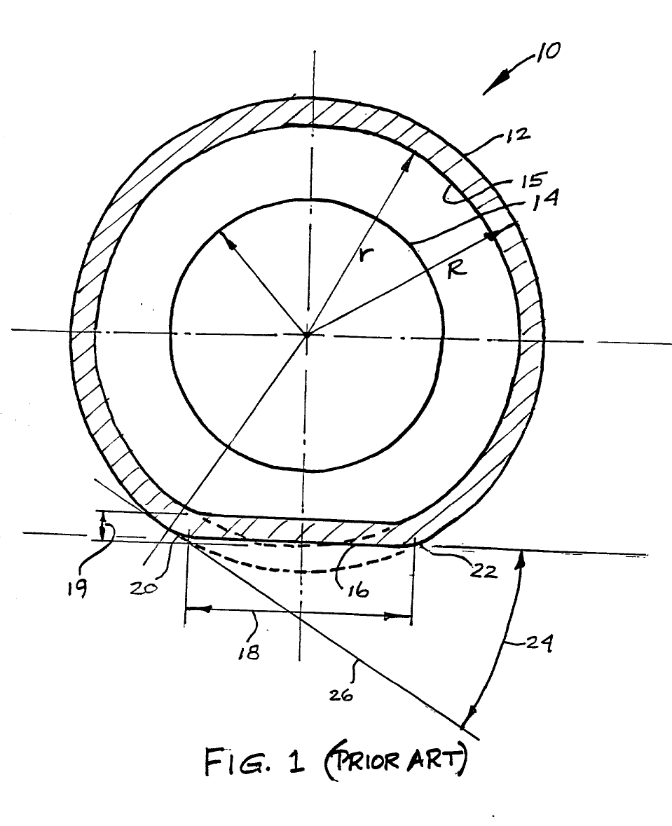

### DETAILED DESCRIPTION OF THE PREFERRED EMBODIMENTS

1. System Overview

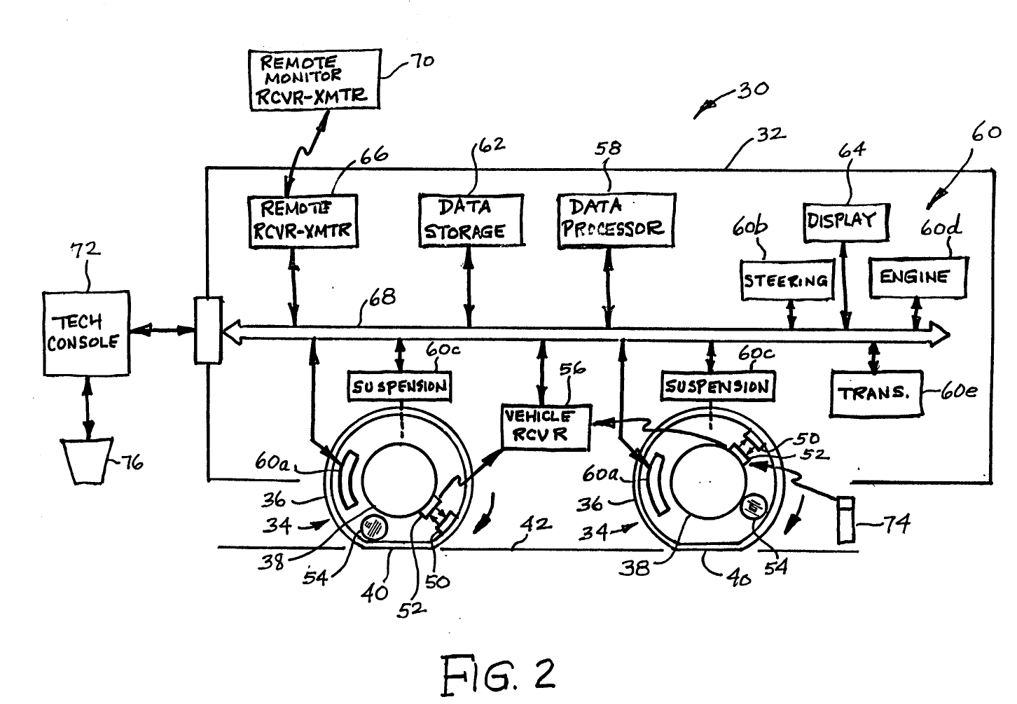

FIG. 2 is a simplified block diagram of a real-time tire monitoring system 30 in accordance with one exemplary embodiment of the present invention. The system 30 is incorporated in a vehicle 32 having a plurality of wheels 34 each carrying a tire 36 mounted on a rim 38. It will be evident that the vehicle 32 may comprise any type of vehicle now existing or developed in the future, adapted to roll or otherwise be transported on pneumatic or other fluid filled tires, such vehicles including, without limitation, passenger cars, trucks, trailers, buses, aircraft, specialized vehicles such as military personnel carriers, and so forth, powered by any kind of motor or engine drive system, whether gasoline, diesel, electric, gas turbines or hybrids thereof. The tires 36 are shown in FIG. 2 in their loaded condition, and accordingly each has a flattened deflection contact region 40 in contact with a load-bearing surface such as a road 42.

The tire monitoring system 30 generally comprises a contact region detector 50 and an associated receiver-transmitter 52 within each tire 36; a tire identifying plaque 54 attached to the sidewall of each tire; and a receiver 56, data processor 58, a distributed control subsystem 60, a data storage unit 62, an operator display 64, a remote receiver-transmitter 66 and a data bus 68 within the vehicle 32. The monitoring system 30 further includes, remote from the vehicle, a remote monitor receiver-transmitter 70 for communicating information to and from the vehicle 32; a console 72 through which a technician interacts with the vehicle 32; a magnetic wand 74 to identify the physical locations of the tires; and a tire identifying plaque scanner 76 to read the parameter information on the tire identifying plaque 54.

Generally, the contact region detector 50 functions to detect tire load-induced deflections, to time the load-induced tire deflection duration and periodicity, and to reduce signal noise. The receiver-transmitter 52 serves to receive the timing information from the contact detector 50, measure tire pressure and temperature, and transmit these data to the vehicle receiver 56. The tire identifying plaque 54 on each tire 36 carries machine-readable data relating to parameter values specific to the tire model. The in-vehicle receiver 56 is adapted to receive data transmissions from all tires 36. The data processor 58 determines tire deformation, tire load, tire molar content, vehicle mass, and the distribution of vehicle mass. The distributed control system 60 comprises adaptive vehicle subsystems such as brakes 60a, steering 60b, suspension 60c, engine 60d, transmission 60e, and so forth, that respond in predetermined fashions to the load, the vehicle mass and the distribution of the vehicle mass. The data storage unit 62 stores the values of parameters and of interim calculations while the operator display 64 provides status information and warnings. The remote receiver-transmitter 66 sends information to the remote monitor receiver-transmitter 70 and the data bus 68 interconnects the system components 56, 58, 60, 62, 64, 66 and 72.

2. The Tire Contact Region Detector 50 and the Receiver-Transmitter 52

Overview: In accordance with the present invention, the approach taken to the detection of the deflection region of a loaded tire is to sense the acceleration of the rotating tire by means of an accelerometer mounted on the tire, preferably within the tire and more preferably on the inner tread lining of the tire. As the tire rotates and the accelerometer is off of the deflection, a high centrifugal acceleration is sensed. Conversely, when the accelerometer is on the flat deflection region and not rotating, a low acceleration is sensed. The deflection points are determined at the points where the acceleration transitions between the high and low values.

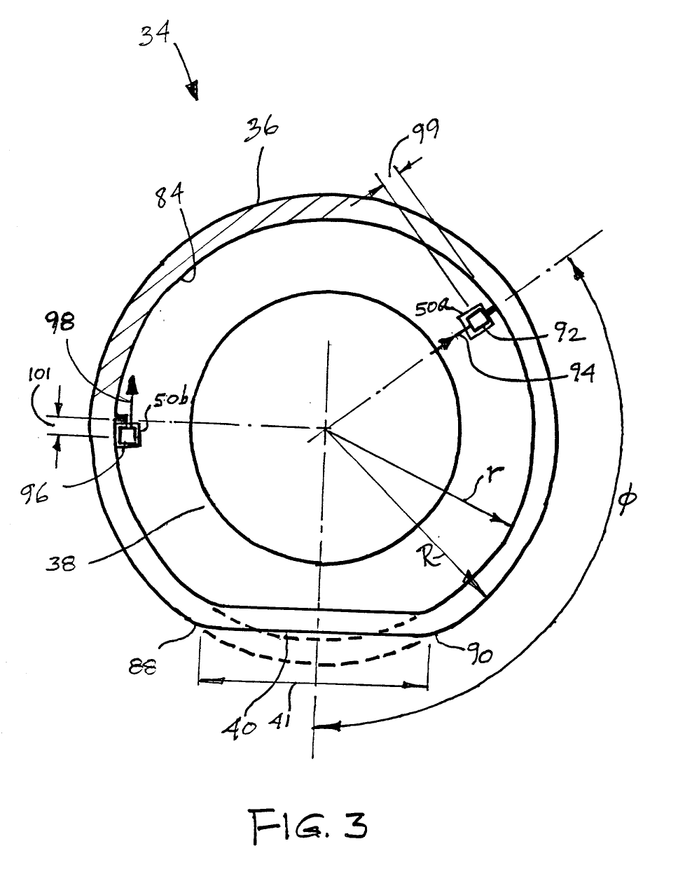

FIG. 3 shows in greater detail one of the vehicle wheels 34 comprising, as noted, a loaded tire 36 mounted on a rim 38. The tire 36 has an inner tread lining 84 and the flat contact region has a contact length 41 delimited by spaced-apart deflection points 88 and 90. The sensing of acceleration may be implemented in one of two ways: first, the contact region detector may take the form of a contact region detector 50a incorporating a radial accelerometer 92 having an acceleration sensing axis 94 aligned or coinciding with a radius of the wheel 34, or second, the detector may take the form of a contact region detector 50b employing a tangential accelerometer 96. For purposes of this invention, a “tangential accelerometer” is defined as one—as shown in FIG. 3—having an acceleration sensing axis 98 orthogonal to a radius of the wheel 34 and parallel with a line tangent to the inner tread lining 84.

The Radial Detector: Turning first to the radial detector 50a, when this detector is off of the contact region 40, the radial accelerometer 92 senses an outward centrifugal radial acceleration given by:

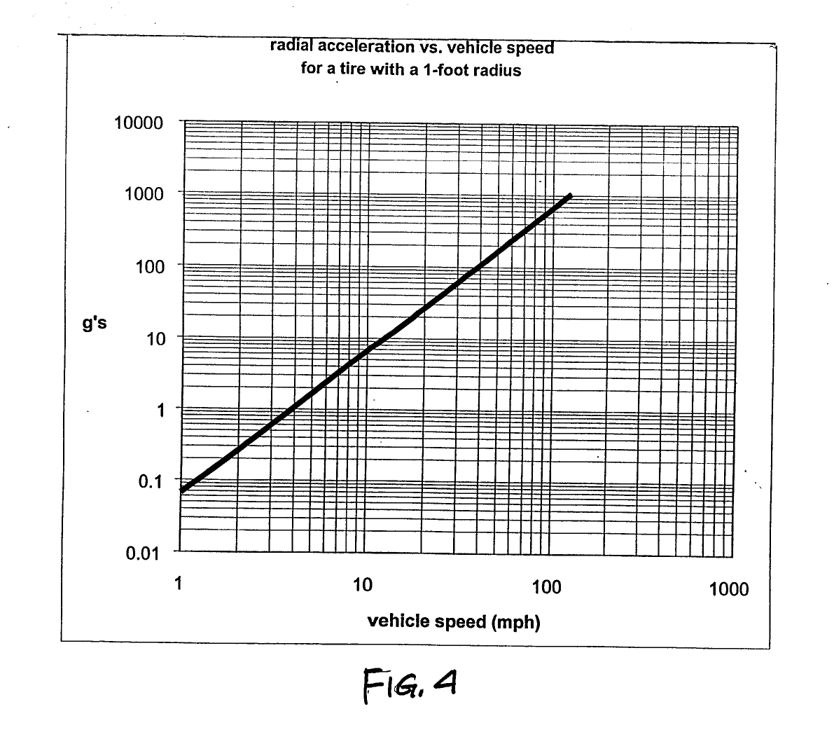

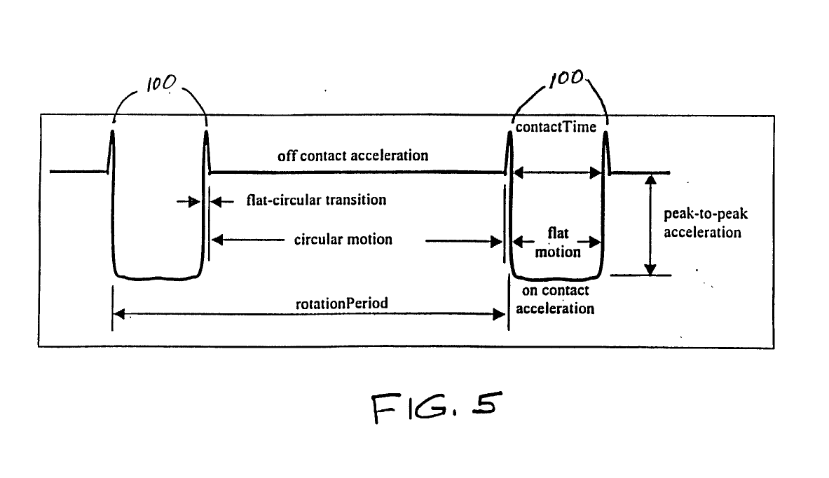

offContactRadialAcceleration=(tireRadius−radialOffset)ω²

where tireRadius is the radius r of the wheel 34 from its center to the tire inner lining 84, ω is the wheel rotation rate in radians/sec, and radialOffset is the offset distance 99 of the accelerometer from the inner lining. As illustrated in FIG. 4, the off-contact acceleration is as much as 8 g's at 10 mph and 667 g's at 100 mph. When on the contact region 40, only the outward acceleration of gravity is sensed. An illustration of the general shape of the accelerometer signal is presented in FIG. 5, where the 1-g signal during motion along the flat contact region 40 has shoulders 100 on both ends that are caused by the motion of the radial accelerometer 92 toward the wheel center at each deflection point 88 and 90.

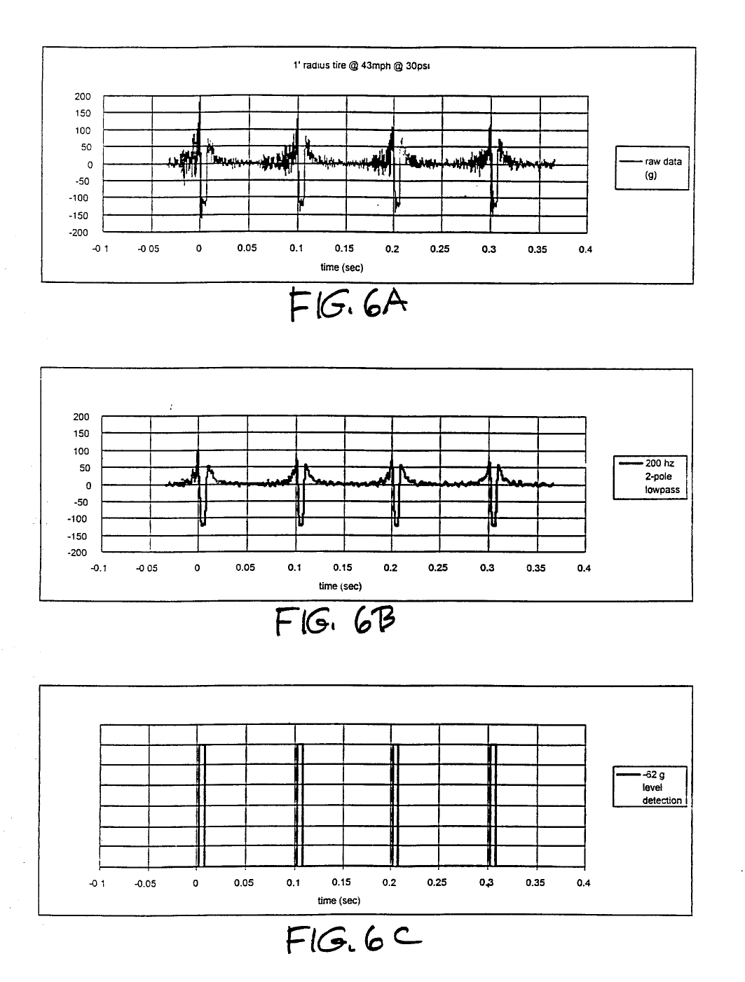

As shown in FIG. 6A, the radial acceleration signal is corrupted by road noise that can be substantially reduced, as seen in FIG. 6B, by low-pass filtering to remove high frequencies. The filtered result is compared to an adaptive threshold (FIG. 6C) to detect the contact region acceleration, and the comparison result is timed to yield the duration of the contact region (contactTime) and the period of the tire rotation (rotationPeriod).

When the radial contact region detector 50a is off of the contact region 40, gravity adds a known co-sinusoidal term to the sensed radial acceleration and is a function of the angular location of the accelerometer with respect to the gravity vector as it rotates with the tire:

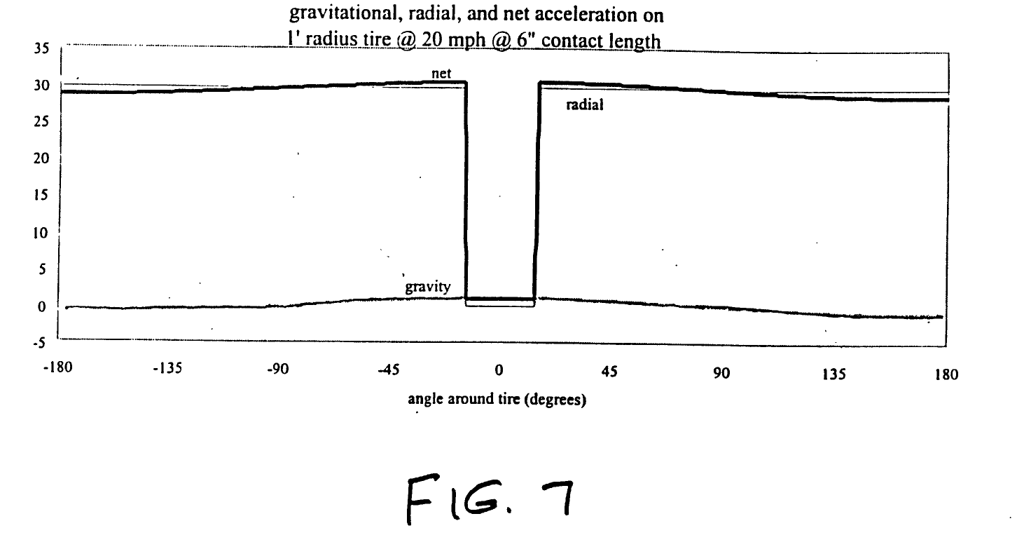

gravityRadial=cos φ

where gravityRadial is measured in g's, and φ is the angular position of the accelerometer with respect to the gravity vector, as illustrated in FIG. 3. Ignoring the shoulders 100, an example of this effect is illustrated in FIG. 7. One manner to compensate for gravity is to subtract its effect by estimating the accelerometer angular gravity orientation, φ, based on an index time point determined at the midtime of the contact region (timeIndex), and thereafter extrapolated as

$$gravityRadial = cos ⟨ 2 π \frac{time - timeIndex}{rotationPeriod} ⟩$$

Another method to correct for gravity is to take advantage of its low frequency (one cycle per revolution) in contrast to the short duration of the contact region signal. A high pass filter with break frequency in Hertz set around

$${f}_{highpass} \approx \frac{1}{6 contactTime}$$

will reduce the gravity signal while retaining the desired contact signal, albeit distorted as the signal band and the blocking band are separate but near. The gravity correction by extrapolation can correct for the gravity signal without distorting the contact signal. Because the radial centrifugal acceleration is so much greater than gravity, gravity can be ignored.

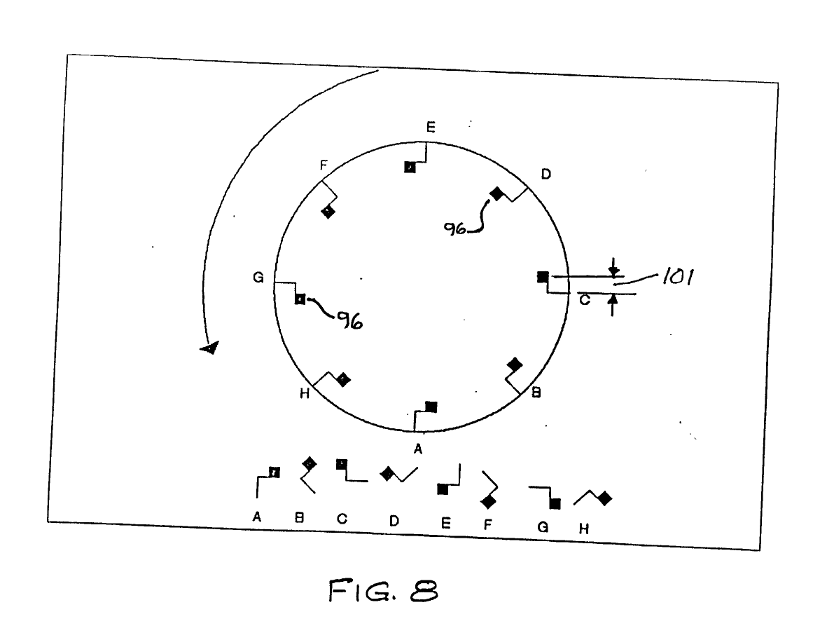

The Tangential Detector: Turning now to the tangential detector 50b, and with reference to FIGS. 3 and 8, the orientation and output of the tangential accelerometer 96 carried by the detector 50b is also affected by the rotation of the wheel 34. The axis of rotation is no longer tireRadius, but the distance 101 the accelerometer 96 is offset from its point of attachment to the tire (tangentialOffset). This means the acceleration sensed when the detector 50b off of the tire contact region 40 is:

offContactTangentialAcceleration=ω²tangentialOffset

and is zero when the detector 50b is on the contact region 40 where it is no longer rotating. As in the case of radial acceleration, shoulders appear in the signal due to the increased rotation rate at the deflection points 88 and 90, and the general shape of the accelerometer signal is presented in FIG. 5.

The tangentially sensed acceleration is not dependent on the tire dimensions and is scaled by selecting tangentialOffset. Independence from tire geometry is an obvious advantage of the tangential contact region detector 50b, and the ability to scale the sensed acceleration is of practical importance since, as shown in FIG. 4, high speeds imply 1000-g accelerations which commonly available sensors may not handle. For example, if the tangential accelerometer 96 is offset 1 inch on a tire having a radius of 12 inches, the sensed tangential acceleration is reduced to 1/12 that of a radial accelerometer. As in the case of the radial acceleration measurement, the tangential acceleration output signal is filtered, threshold-detected using a comparator, and timed in the same manner as in the case of radial acceleration.

Like the radial detector 50a, when the tangential contact region detector 50b is off of the contact region 40, gravity adds a known sinusoidal element to the tangential acceleration:

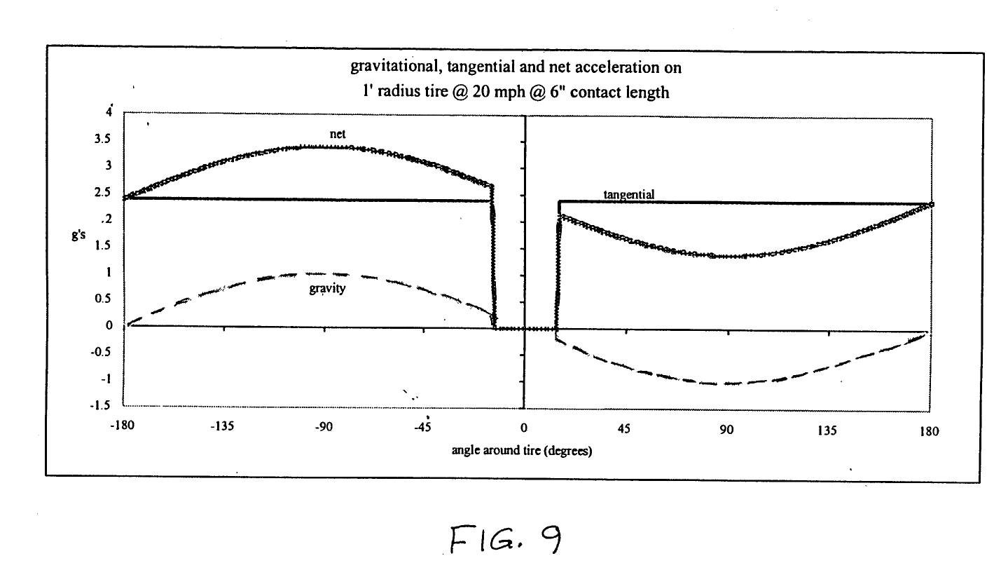

gravityTangential=sin φ

where gravityTangential is measured in g's and is illustrated (ignoring ‘shoulders’) in FIG. 9, and can be extrapolated as

$$gravityTangential = sin ⟨ 2 π \frac{time - timeIndex}{rotationPeriod} ⟩$$

Because the centrifugal acceleration signal is reduced by scaling, gravity has a greater effect on the tangential accelerometer than on the radial one, but makes a zero contribution on the contact region.

The tangentially sensed acceleration also includes vehicle acceleration that couples in through the acceleration of the tire circumference, and this is equal to the vehicle acceleration. This acceleration is a low amplitude (a 1-g acceleration means you speed from zero to 60 mph in less than 3 seconds) and low frequency (once per tire rotation) co-sinusoidal term that is at its maximum on the contact region, and can be reduced by a high-pass filter.

An Axial Detector: An axial detector is also perpendicular to the tire radius, but with its accelerometer axis oriented along the wheel axis rather than along the tire circumference. An axial detector is used to measure the yaw-induced acceleration of the wheel, when the vehicle is maneuvering a curve, and also provides information on the shear forces on the tire where it contacts the road. An axial detector is used in combination with either tangential or radial accelerometer in order to perform acceleration measurements when on the contact region. An axial detector can be implemented as an additional independent sensing axis on the existing radial or tangential accelerometer.

Filtering Road Noise: Regardless of whether the accelerometer is oriented radially (92) or tangentially (96) or axially, its output signal is corrupted by road noise caused by the tire rolling on a road surface that is roughened by pits, rocks and gravel. These cause the tire tread to deform and accelerate in primarily a radial direction, and these accelerations are termed “road noise”. The response of the tire to these surface imperfections is similar to its impulse response: if the tire is struck, it responds with a damped ringing deflection. The natural frequency of the ringing is high enough that a low-pass filter removes its effect. The frequency, in Hertz, of the low-pass should be around

$${f}_{lowpass} \approx \frac{3}{2 contactTime}$$

to reduce the road noise while retaining the contact acceleration signal.

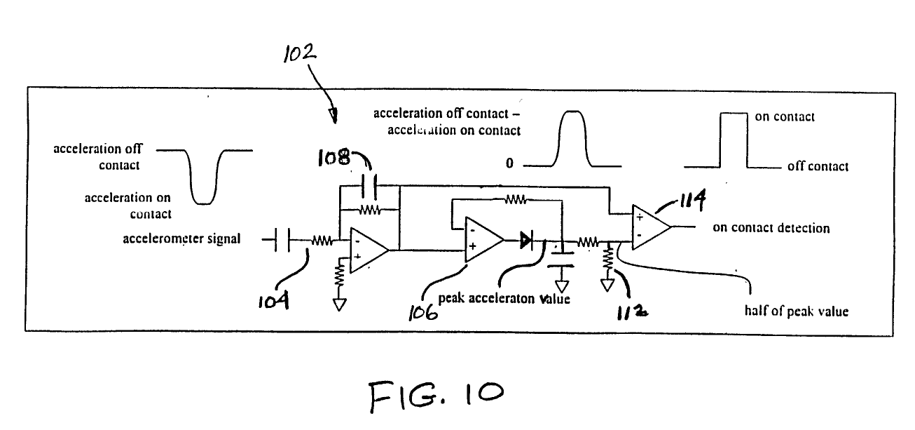

Threshold Detection: The on-contact acceleration signal generated by the accelerometer 92 or 96 comprises pulses that are short term compared to the pulses of the off-contact signal, and they can be detected by comparing the filtered signal to a threshold level. A simplified schematic of an exemplary analog adaptive threshold circuit 102 used to filter the signal, set the threshold level, and detect the on-contact pulses is illustrated in FIG. 10. The circuit 102 comprises a high-pass filter 104 to reject the static off-contact and low frequency gravity and vehicle acceleration signals, a low-pass filter 108 to reject road noise, a peak detector 106 to track the peak AC acceleration (peakToPeakAcceleration), a voltage divider and peak detector bleed circuit 112 to set the threshold at half of the peak value, and a comparator 114 to determine the presence of the contact region 40. The threshold is set at half the difference between the off- and on-contact signals in order to equalize the rising and falling signal delays through the filters 104 and 108.

Verifying Proper Operation: In order to determine that the accelerometer and other electronics are working properly, the peakToPeakAcceleration, ignoring the ‘shoulders’ and gravity, can be compared to an anticipated value determined from the rotationPeriod:

$$\begin{matrix}anticipatedPeakToPeakAcceleration = rotationArm \times ω \\ = 4 {π}^{2} \frac{rotationArm}{{rotationPeriod}^{2}}\end{matrix}$$

The peakToPeakAcceleration of the high pass filtered signal is the difference between the accelerations off-contact acceleration and the on-contact. The rotationArm is (tireRadius−radialOffset) for the radial accelerometer, and tangentialOffset for the tangential one.

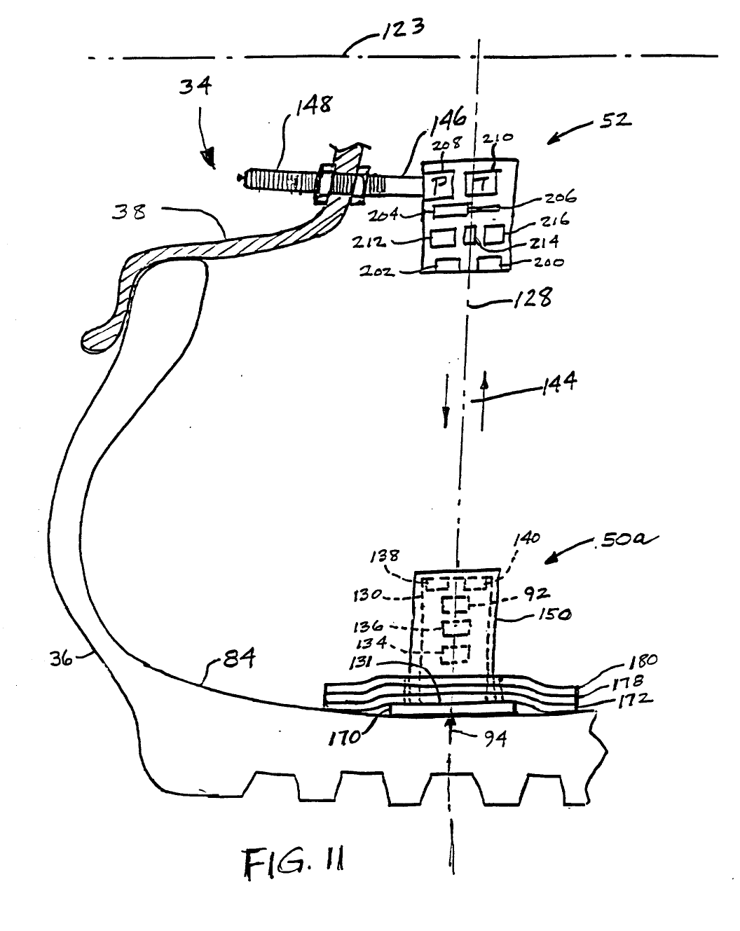

Implementation of the Radial Contact Region Detector 50a: Referring to FIG. 11, there is shown a partial cross section of the vehicle wheel 34 with the pneumatic tire 36 mounted on the wheel rim 38. The wheel 34 has an axis of rotation 123. Secured to the tire and preferably to the inner tread lining 84 thereof is a contact region detector 50a for detecting radial acceleration in accordance with the specific embodiment under consideration. Although it is evident that the detector 50a may be secured to the lining 84 at various locations along the axial direction, the detector 50a is preferably mounted symmetrically about a central radially-extending plane 128. Although more than one detector 50a may be secured to the lining 84 at various circumferential locations along the lining, as a practical matter only one such detector will be installed in each tire.

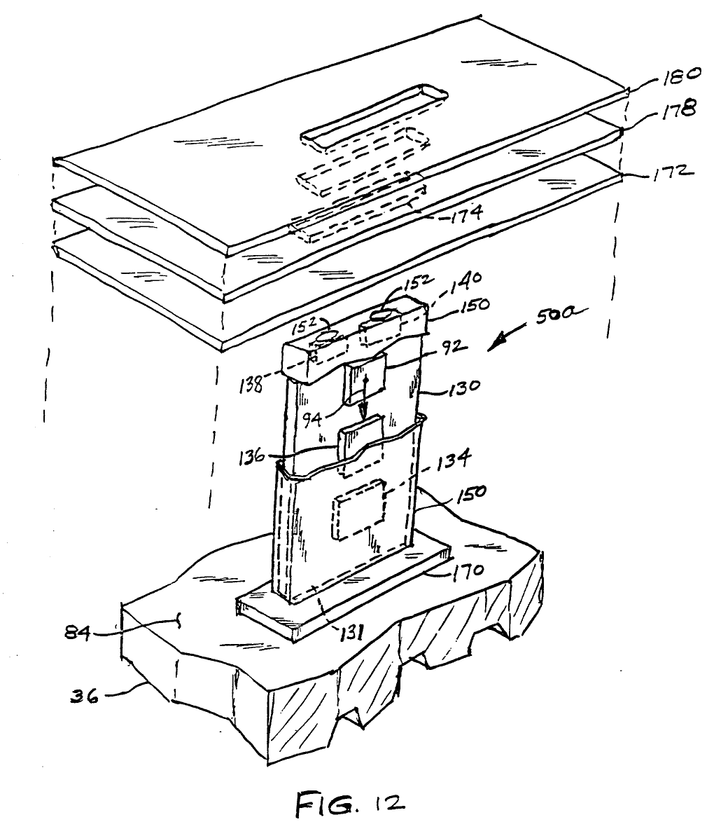

With reference now also to FIG. 12, the contact region detector 50a comprises a substrate preferably in the form of a printed circuit board (PCB) 130 having an outer end 131. The PCB 130 carries the radial accelerometer 92, a battery 134, a data processor 136, a photo detector 138, a photo emitter 140, and associated power control and support circuitry. The contact region detector 50a collects and processes data from the accelerometer 92, and communicates bi-directionally with the nearby, but physically separate, tire receiver-transmitter 52 over an optical link 144 coupling the photo detector and emitter pairs (138, 202) and (200, 140). Although an optical communications link is preferred, it will be evident that an RF link or electrical conductors may be used instead. The receiver-transmitter 52 is mounted on an extension 146 of a tire valve 148 secured in a well-known fashion to the wheel rim 38.

As will be explained below, the contact region detector 50a may be mounted so that the accelerometer 92 is close to the inner tread lining 84. However, the accelerometer 92 is preferably mounted on a substrate such as the PCB 130 that projects into the cooler regions of the interior of the tire. Further as a result of mounting the accelerometer remotely from the lining 84, the structure of the accelerometer 92 is not subject to the high level repetitive stresses that would be otherwise imposed on the accelerometer by the rotating loaded tire as it flexes at the deflection points 88 and 90. Still further, the preferred mounting method of the accelerometer makes possible the use conventional printed circuit or hybrid manufacturing technologies, and the entire contact region detector 50a may be protected by an enclosure 150 with windows 152 for the optical communication link.

In the exemplary embodiment shown in FIG. 11, the major surfaces of the PCB 130 lie in axially directed planes perpendicular to the central radial plane 128. It will be evident, however, that alternatively the major surfaces of the PCB 130 may lie along a plane coincident with the plane 128; other orientations are, of course, possible.

As noted, the radial accelerometer 92 has an acceleration sensing axis 94 coincident with a radius of the wheel 34.

The contact region detector 50a is mounted on the inner lining 84 in a flexible yet robust and firm manner. Adhesives such as epoxies or other such bonding agents cannot be used directly on the detector because the flexing of the tire, as the deflection points 88 and 90 (FIG. 3) come and go, will weaken any bonding agent that does not also interfere with the required tire flexibility.

As seen in FIGS. 11 and 12, the detector 50a includes a base plate 170 to which the PCB 130 is secured at its outer end 131. The PCB 130 extends perpendicular to the base plate 170. As best seen in FIG. 11, the detector 50a is attached to the inner lining 84 by means of a modified conventional flexible tire patch 172, the base plate 170 being sandwiched between the patch 172 overlying the inner surface of the base plate 170 and the tire lining 84 under the outer surface of the base plate with the effect of providing a flexible mount that does not interfere with the tire action yet firmly holds the detector in place. The patch has an outer portion extending beyond the periphery of the base plate, the outer portion of the patch being bonded to the inner surface 84. The tire patch 172 has a central opening 174 through which the PCB 130 and enclosure 150 projects, as shown in FIG. 12. This arrangement places the detector circuitry into the air cavity within the tire, the coolest part, and the tire patch 172 may be comprised of a commercially available product (modified only to include the central opening 174) as it need not conform to the height dimensions of the detector 50a. As the environment within a tire is very humid and dusty, the PCB 130 and the circuitry carried thereby are preferably enclosed within a housing 150 to protect those components, as already noted.

It is also desirable to be able to remove the contact region detector 50a and to re-attach it to the lining of a replacement tire. A simple way of providing for this is to include one or more extra tire patches such as the slotted patches 178 and 180, slipped on the PCB over the patch 172, as shown in FIGS. 11 and 12. When the detector 50a is to be installed on a replacement tire, the lowest tire patch 172 adhesively secured to the lining 84 is simply cut away permitting removal of the detector 50a from the old tire and exposing the next patch 178 for attaching the detector to the lining of the new tire.

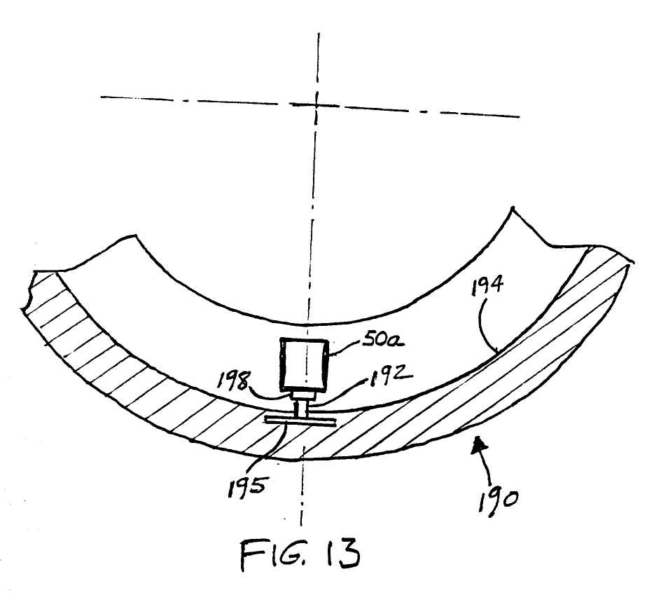

With reference to FIG. 13, as an alternative to the use of tire patches, during fabrication of a tire 190, the tire may be provided with a post 192 projecting radially inwardly from the tire lining 194. The post 192 has a flexible base 195 molded in place within the tread wall of the tire 190. A radial contact region detector 50a is detachably secured to the post 192 by means of at least one fastener 198 having surfaces mateable with corresponding surfaces on the post 192. By way of example, the fastening arrangement may simply comprise a threaded attachment.

As noted, the contact region detector 50a is battery operated and, to conserve power, is preferably optically activated, as needed, using a pulsed optical signal from the receiver-transmitter 52. The pulsed signal activates the photo detector 138 on the contact region detector 50a that in turn switches on the battery 134 to power the detector.

When activated, the contact region detector 50a holds its power switch on, the optical signal from the receiver-transmitter 52 is switched off, and the contact region detector begins an observation period that may last several tire rotations. During this period the accelerometer signal is compensated for the influence of gravity, vehicle acceleration, and road roughness; a threshold is determined that identifies the transitions between on- and off-contact region; and the time duration of the contact region (contactTime) and of the period between contact regions (rotationPeriod), are measured as well as the peak-to-peak acceleration change between on- and off-contact (peakToPeakAcceleration). The time durations are used to determine the contact length and tire rotation rate, and the peak-to-peak acceleration difference is used to determine that the contact region detector is operating properly.

The acceleration environment sensed by the detector 50a may be impacted by a rough road surface and, to reduce measurement errors, several measurements of the duration periods and of the peak-to-peak acceleration are made, one per tire rotation. The three measurement sets are statistically processed to eliminate inconsistent samples by applying an elimination method based on the Student-t distribution. The means and standard deviations of the remaining samples of each set are calculated for transmission to the receiver-transmitter. These means and standard deviations provide information used elsewhere in the invention to accurately calculate values and to determine their probable uncertainty.

The three sets of means and standard deviations and self-test results are formatted into a digital packet and transmitted to the receiver-transmitter using the photo emitter. Thereafter the contact region detector 50a releases its power switch and turns off.

The contact region detector 50a may be digitally implemented, as follows:

the detector 50a is activated by an optical pulse from the tire receiver-transmitter 52 whereupon it holds its power on;

the analog accelerometer signal is sampled and converted to digital values;

road noise is reduced from the sampled and digitized acceleration values by low-pass filtered using digital algorithms that adjust to the signal frequencies;

the effects of gravity and vehicle acceleration are reduced from the low-pass filtered, digitized and sampled acceleration values by high-pass filtering using digital algorithms that adjust to the signal frequencies resulting in an AC-coupled signal that rides on the off-contact acceleration signal and is perturbed from it by the on-contact accelerations;

the AC coupled, filtered, digitized, sampled values are peak detected over multiple tire rotations, and the peakToPeakAcceleration values are averaged and used to generate the on-contact vs. off-contact threshold;

the AC coupled, filtered, digitized, sampled values are compared to the threshold to detect the on-contact off-contact transition times;

because the AC coupled, filtered, digitized, sampled values are unlikely to equal the threshold, but will lie on one or the other side, the transition sample value and the prior sample are linearly interpolated in time to the threshold value resulting in improved estimates of the transition times;

the interpolated transition times are differenced to determine the contactTime and rotationPeriod;

several samples each of the contactTime, rotationPeriod, and peakToPeakAcceleration are collected over several tire revolutions and, for each group, samples statistically inconsistent with the others are discarded;

the means and standard deviations of the remaining samples are calculated;

when the AC coupled, filtered, digitized, sampled values indicate the device is off of the contact region, and the optical link axes are aligned, then

the means and standard deviations of contactTime, rotationPeriod, and peakToPeakAcceleration are reported over the digital optical link 144 to the tire receiver-transmitter 52; and

the detector releases its power and turns off.

The high-pass and low-pass filters 104 and 108 preferably utilize any of a variety of known infinite impulse response (IIR) or finite impulse response (FIR) filter algorithms with break frequencies that adjust to the signal timing.

The standard statistical algorithm for eliminating inconsistent samples using the Student-t distribution is based on the mean and standard deviation of the sample populations where inconsistent samples are those farther than a prescribed distance from the means of the others. The distance is a multiple of the sample standard deviation. The means and standard deviations of the remaining samples are determined and reported to the tire receiver-transmitter 52.

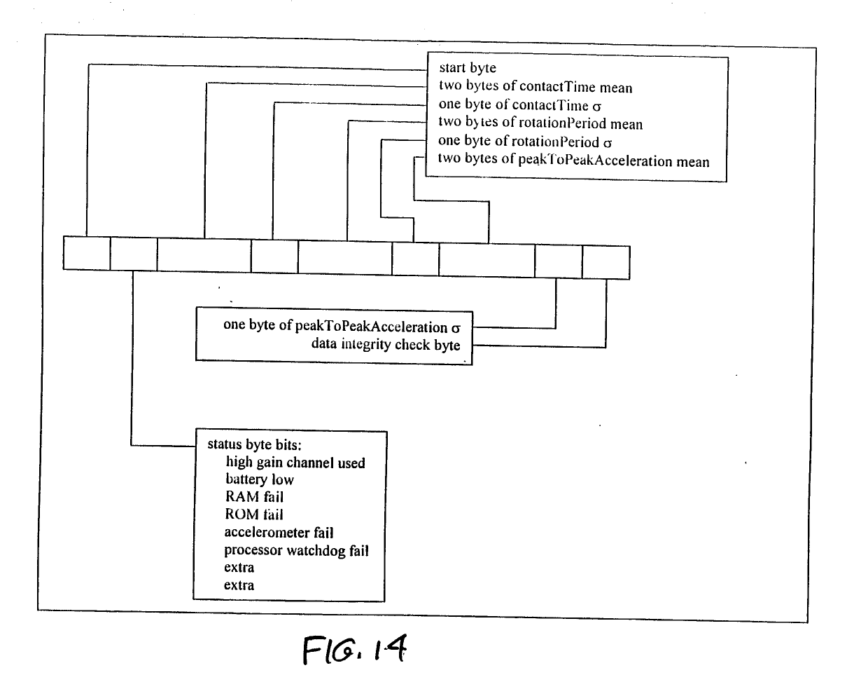

The digital optical data link of light-on and light-off bits may be implemented as a Manchester encoded formatted packet with a start byte and terminated with a data integrity check byte (cyclic redundancy code, sumcheck, . . . ) as illustrated in FIG. 14.

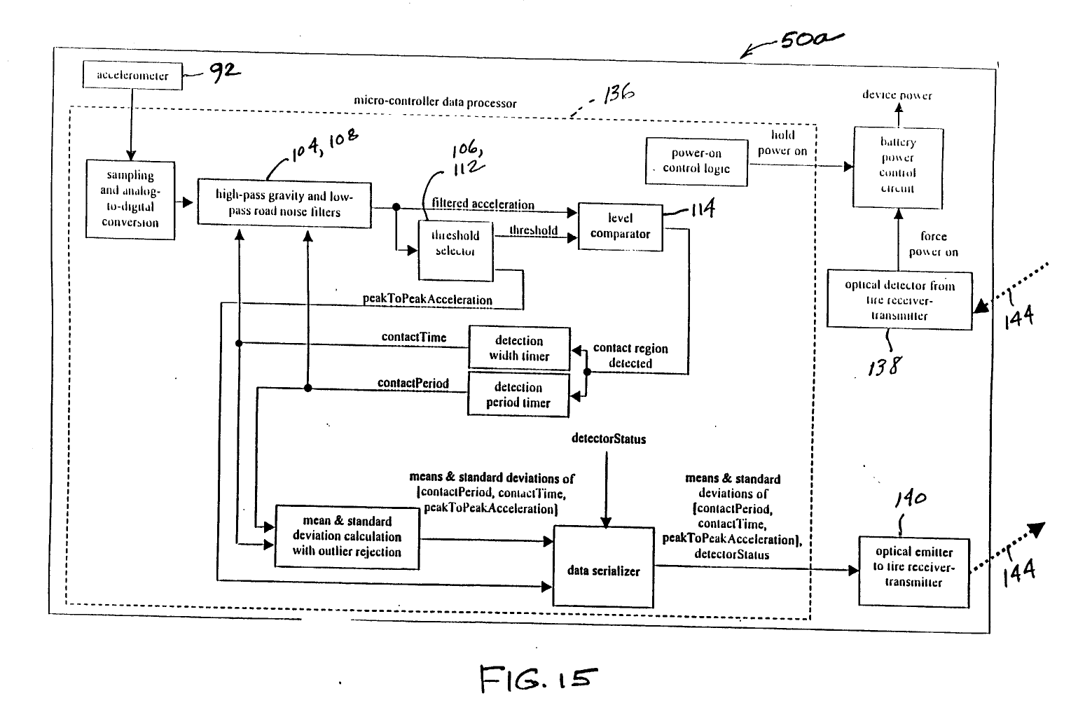

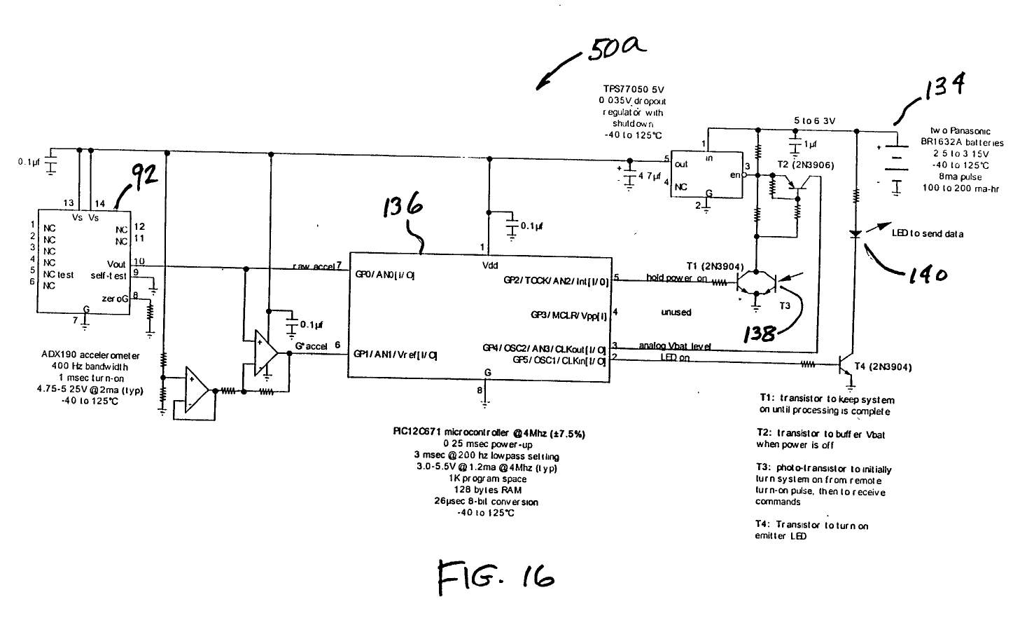

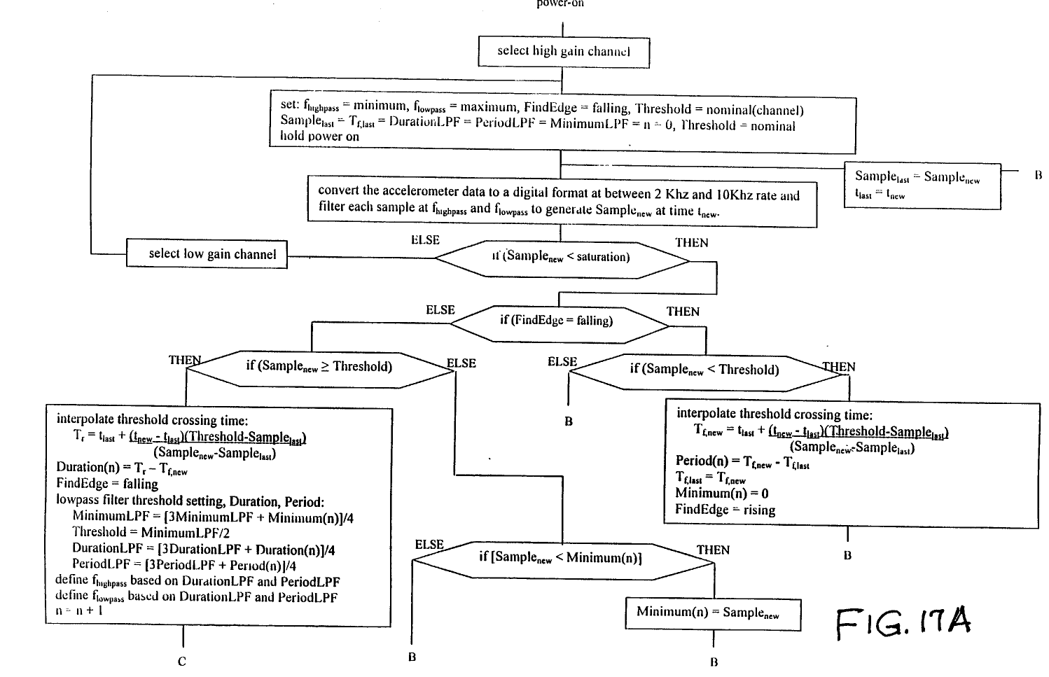

A block diagram of the circuitry of the contact region detector 50a is shown in FIG. 15, a schematic is shown in FIG. 16, and a logic flow chart appears in FIGS. 17A and 17B. The detector 50a is kept simple and comprises a peakToPeakAcceleration, rotationPeriod, and contactTime data collector following the logic described herein.

The contact region detector circuitry uses the Analog Devices ADXL190±100 g MEMS 14-pin surface mount device. This integrated circuit includes a 400 Hz low-pass, is rated −55° C. to 125° C., requires a single 5V supply, and produces a 0.1 to 4.9V linear output. Motorola and SensoNor also produce MEMS accelerometers. The micro-controller is the Microchip PIC12C671 8-pin surface mount device with onboard 1K program memory, 128 bytes RAM, four 8-bit A/D converters, 4 Mhz calibrated RC clock, power-on reset, and is rated −40° C. to 125° C.

Because the sensed acceleration is not centered about zero, the accelerometer is biased to map its −100 g to +100 g range into −20 g to +180 g. According to FIG. 4, this provides an operational range of up to around 50 miles per hour with a 1-foot radius tire. Higher ranges require an accelerometer with a greater dynamic range, or a tangentially oriented accelerometer 96.

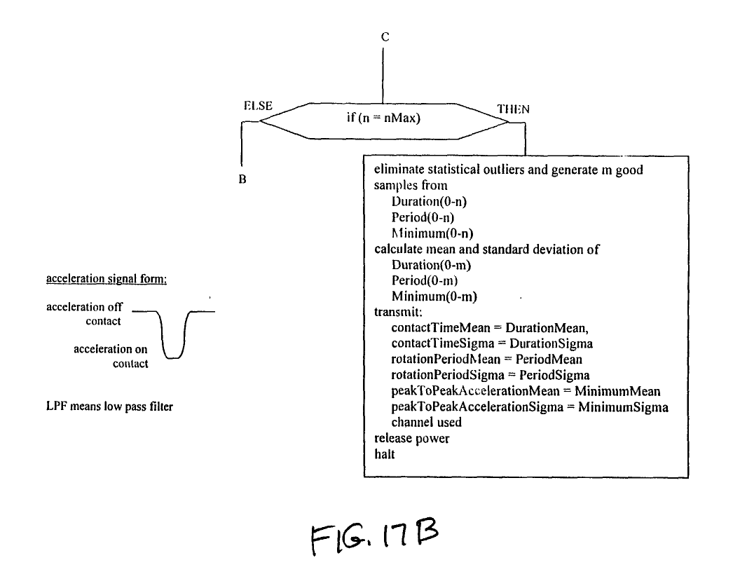

Since the contact region detector 50a and the tire receiver-transmitter 52 communicate optically, they must be located within line-of-sight of each other. As the distance between the detector 50a and the tire receiver-transmitter 52 is only a few inches across the tire, there is little optical ambient noise and the communication link is secure yet low power. As shown in FIG. 18, although the axes of the optical link 144 between the detector and the receiver-transmitter are aligned when the detector is off of the contact region 40, the axes are not aligned when the detector is between either of the deflection points 88, 90 and the middle of the contact region 40. This misalignment may be dealt with in conventional fashion by using a combination of lenses, wide-angle emitters, and multiple detectors to allow for the misalignment, and by transmitting information only while the contact region detector 50a is off of the contact region 40 and the axes are aligned.

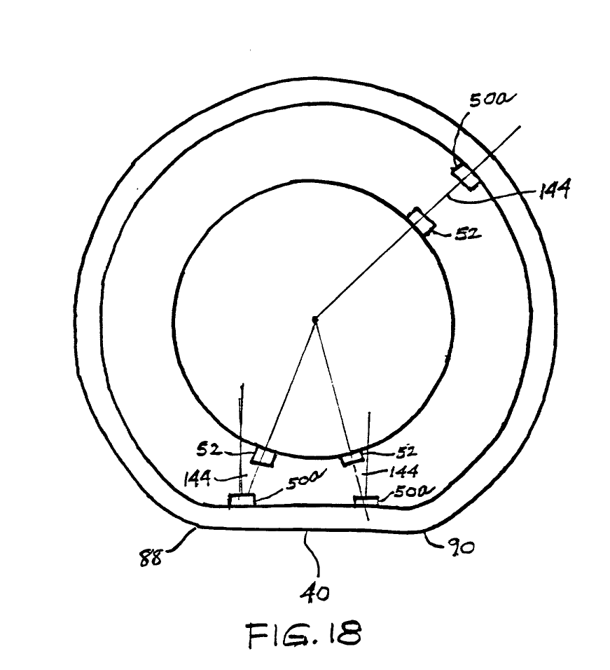

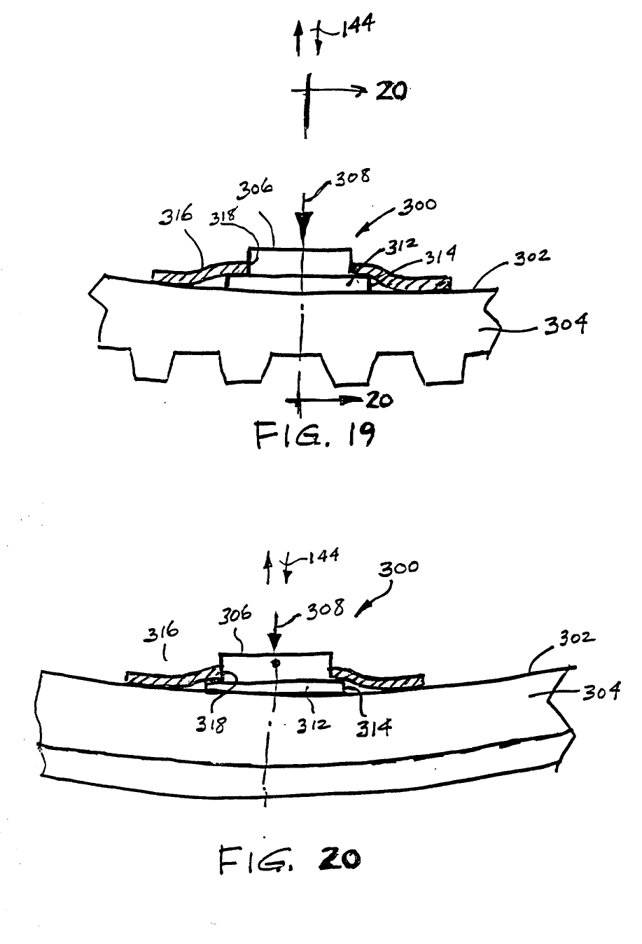

Referring to FIGS. 19 and 20, there is shown a radial contact region detector 300 in accordance with an alternative embodiment of the present invention. The operation of the detector 300 is in all respects the same as that of the radial detector 50a. The contact region detector 300 is shown mounted on the inner tread lining 302 of a vehicle tire 304. The contact region detector 300 comprises a low profile housing 306 containing the various above-described detector elements shown in FIGS. 11 and 12 and comprising a radial accelerometer, a battery, a data processor, a photo detector, a photo emitter, and associated electrical power control and support circuitry. As before, the photo detector and emitter form parts of an optical communication link for transferring data between the detector 300 and an in-tire receiver-transmitter (not shown). As mentioned, an RF communication link or conductors may be used instead of an optical link. The accelerometer within the housing 306 has its acceleration sensing axis coincident with a radius 308 of the tire. The detector 300 includes a base plate 312 attached to the housing 306 and having a periphery 314 extending beyond the confines of the housing 306. As before, the detector 300 may be conveniently held in place on the inner tread lining 302 by means of a modified, conventional adhesive tire patch 316, the base plate 312 being sandwiched between the patch 316 and the inner tread lining 302. The tire patch 316 is modified to have a central opening 318 through which the detector housing 306 projects. Alternatively, the detector 300 may be secured to the inner tread lining 302 by means of the post and fastener technique shown in FIG. 13. The detector 300 of the alternative embodiment has the advantage of being compact although the components therein lie somewhat closer to the hot inner tread lining than those of the embodiment of FIGS. 11 and 12. Nevertheless, the fact that the detector is not in direct contact with the inner tread lining but is spaced therefrom exposes the device to the cooler regions of the tire cavity. Although not shown in FIGS. 19 and 20, spare patches similar to the patches 178 and 180 in FIGS. 11 and 12, may be stacked over the patch 316 to facilitate the installation of the detector 300 on a replacement tire.

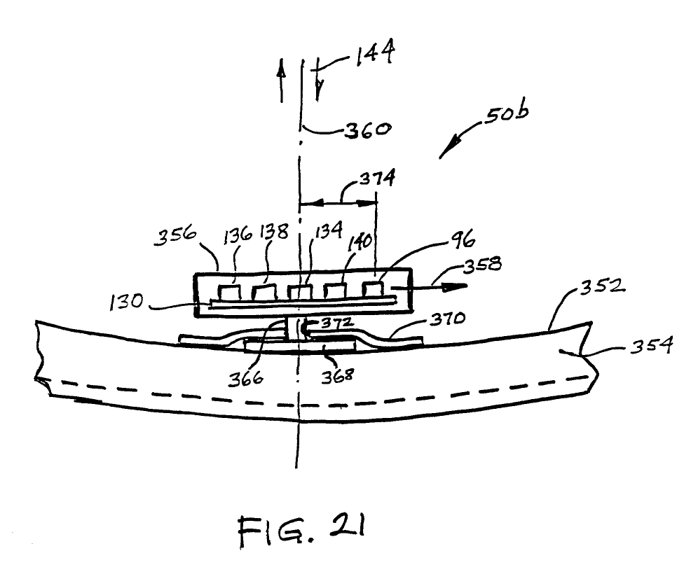

Implementation of the Tangential Contact Region Detector: Turning to FIG. 21, there is shown in greater detail a structural implementation of the tangential contact region detector 50b in accordance with a preferred embodiment thereof. The tangential contact region detector 50b is mounted on an inner tread lining 352 of a vehicle tire 354. The contact region detector 50b comprises a housing 356 containing the various above-described detector elements shown in FIGS. 11 and 12 and comprising a PCB 130, an accelerometer 96, a battery 134, a data processor 136, a photo detector 138, a photo emitter 140, and associated electrical power control and support circuitry. As before, the photo detector and emitter form parts of an optical communication link 144 for transferring data between the detector and an in-tire receiver-transmitter (not shown); again, it will be evident that an RF or conductor communication link may be employed instead. The accelerometer 96 within the housing 356 has its acceleration sensing axis 358 perpendicular to a radius 360 of the tire and tangential to its circumference, that is, along an axis extending in the direction of the rotation of the tire. The detector housing 356 is carried by a post 366 having an outer end coupled to a base plate 368 held in place, as before, against the inner tread lining 352 by means of a conventional adhesive tire patch 370 modified to define an opening 372 through which the post 366 projects. Alternatively, the detector 50b may be secured to the inner tread lining 352 by means of the post and fastener technique shown in FIG. 13. It will be seen that the accelerometer 96, by virtue of its being mounted on an outer end of the PCB 130, is offset from the post 366 by a distance 374 which is the requisite tangential offset 101 (FIG. 8.).

As yet another alternative, the housing 356 may be detachably secured to the post 366, for example by means of a threaded connection. In this way, the housing 356 may be separated from the post 366 and attached to a post and base plate mount in a replacement tire. It will be evident that this alternative expedient applies as well to the radial contact region detector 50a.

If the PCB 130 layout is such that the tangential offset 101 is 1-inch on a 1-foot radius tire, the acceleration sensed by a tangential contact region detector 52b is scaled down by 1/12 in comparison with that sensed by a radial contact region detector 52a. This means that the −20 to +180-g biased ADXL190 accelerometer can linearly sense the equivalent of a −240 to +2160-g radial acceleration range and, turning to FIG. 4, the tangential contact region detector 52b can operate up to around 180 miles per hour.

The tangential contact region detector 50b can also be mounted using the low profile approach of FIGS. 19 and 20. The tangential offset 101 is the distance from the midpoint of the base plate 312 to the position of the accelerometer 96 within the enclosure 306.

Implementation of Tire Receiver-Transmitter 52: As noted, in accordance with one embodiment of the invention, the tire receiver-transmitter 52 maybe mounted within the tire 36 on an extension 146 of the valve stem 148 and a few inches across the tire airspace from the contact region detector 50. With reference to FIG. 11, the receiver-transmitter 52 comprises a photo detector 200, a photo emitter 202, a radio frequency transmitter 204, an antenna 206, a pressure sensor 208, a temperature sensor 210, a battery 212, a magnetic sensor 214, and a processing unit 216. The unit 52 communicates with the associated contact region detector 50 using an optical link 144, and with vehicle radio frequency receiver 56 using the transmitter 204 and the antenna 206. Except for the optical elements, such devices are currently available from manufacturers such as Johnson Controls, TRW, Lear, SmarTire and Siemens and are being used in vehicles to report tire pressure and temperature.

On a periodic basis, the receiver-transmitter 52 pulses the optical emitter 202 to turn on the contact region detector 50, and acquires the digital optical data from the contact region detector using the optical detector 200. The periodicity lengthens as the reported period between contact regions indicates the vehicle is not moving, or moving too slowly, and shortens as the reported period shortens indicating the vehicle is moving.

Having received the contact region detector data, the receiver-transmitter 52 measures the tire air pressure and temperature using its sensors 208 and 210 and transmits these measurements, the contact region detector data, and a code uniquely identifying it from any other tire receiver-transmitter on the vehicle, to the vehicle receiver 56 using randomly timed digital radio frequency bursts to avoid transmissions from other tires.

Because there are several tires reporting and only one vehicle receiver 56, the transmissions can overlap and garble the information. Although the loss of a single transmission is not problematic since another transmission will be sent at a later time, problems arise if two or more tire receiver-transmitters become synchronized for a prolonged time. Inadvertent synchronization is typically solved in existing tire pressure and temperature monitoring systems by having each tire receiver-transmitter randomized its transmission times.

Having transmitted its data to the vehicle receiver 56, the receiver-transmitter 52 programs the next time it should turn on, based on the period between contact regions as reported by the tire contact region detector, and turns off.

The tire receiver-transmitter 52 also has a magnetic sensor 214 to detect the magnetic field from the remote wand 74. When the magnetic field is sensed, the receiver-transmitter 52 is triggered on whereupon it transmits to the vehicle receiver 56 an indication that the wand 74 triggered the transmission, and includes the identification number of the receiver-transmitter.

A digital implementation of the receiver-transmitter 52 is part of this embodiment where:

the receiver-transmitter 52 includes a timer to wake itself up at a programmed time;

the unit 52 includes a magnetic sensor 214 to wake itself up if the wand 74 is applied;

an optical pulse is generated to activate the tire contact region detector;

the pressure and temperature are read from the sensors 208 and 210;

the optical data from the contact region detector is acquired and data validation is attempted;

if the contact region detector data is invalid, the data is ignored and an indication is accordingly added to message to the vehicle receiver;

the pressure, temperature, and acceleration detector data are transmitted using a radio frequency transmitter to the vehicle receiver using a randomized pattern;

the next time data is to be acquired is determined from the rotationPeriod data within the acceleration detector data and programmed into the timer; and

the unit 52 turns off.

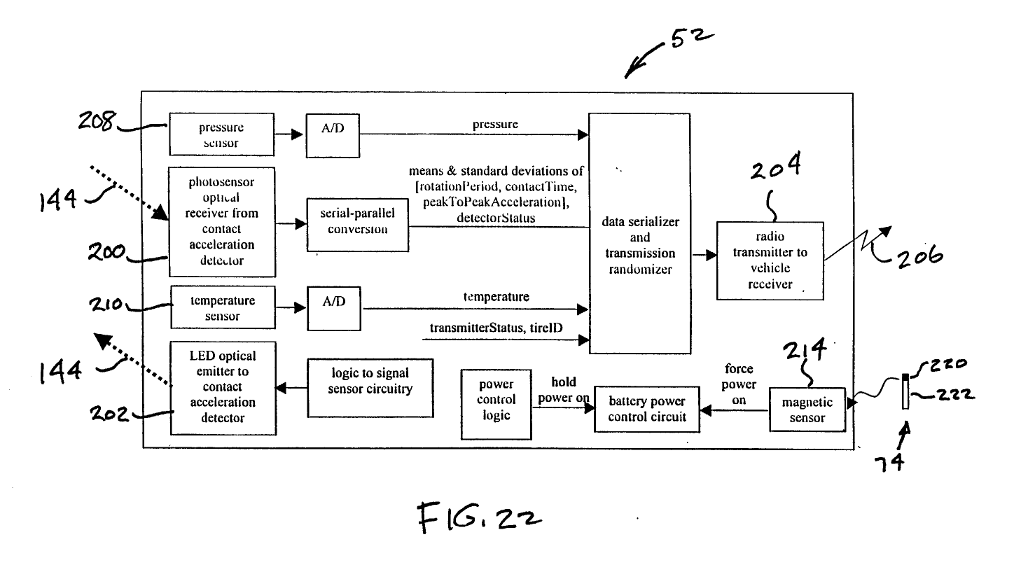

A block diagram of the tire receiver-transmitter 52 is shown in FIG. 22.

The pressure and temperature sensors 208 and 210 of the receiver-transmitter 52 may comprise any of the various devices presently available from manufacturers such as NovaSensor, National Semiconductor, SensoNor, and so forth. The magnetic sensor 214 may comprise any of the various Hall Effect or reed switch integrated circuit devices made by Honeywell, Meder Electronics, and others.

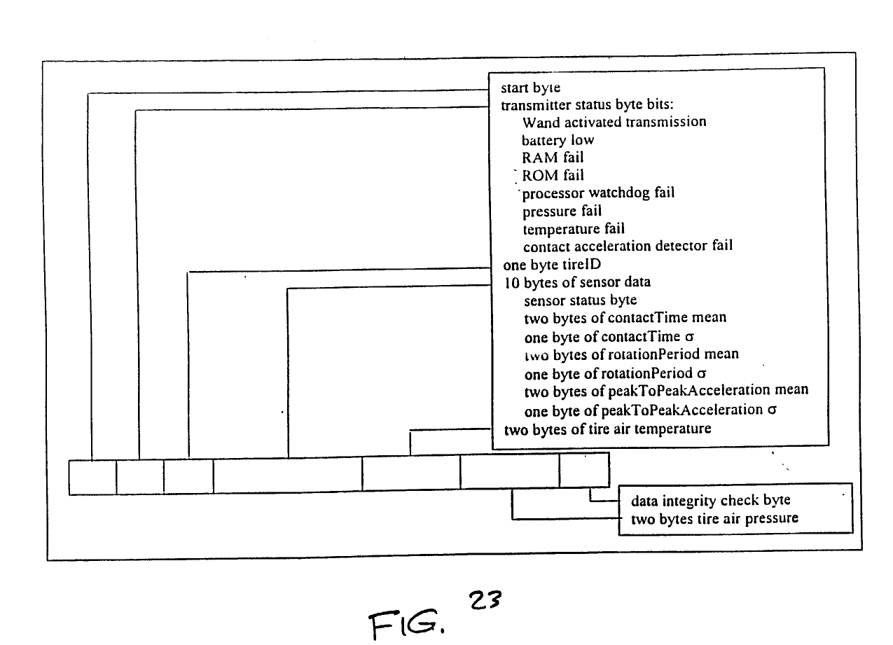

The collected data are transmitted by the receiver-transmitter 52 to the vehicle receiver 56 along with status information, the tireID, and a data verification byte using Manchester encoded formatted messages, illustrated in FIG. 23. The contact region detector data is validated if the start byte is correct and the data re-creates the integrity check byte.

It will be evident that the receiver-transmitter 52 and the contact region detector 50 (whether of the radial or tangential type) may be integrated into a single structure instead of comprising two separate, spaced apart structures as shown, for example, in FIGS. 2 and 11. Such a single, integrated structure may be mounted on an inner tire surface utilizing any of the expedients shown in FIGS. 11-13 and 19-21. It will be further evident that such an integrated unit could be embedded within the wall of the tire although, as indicated, such a mounting arrangement may be less desirable because of the temperatures and stresses imposed on the structure.

3. The Remote Wand 74

The physical location of each tire 36 is important to the mass and distribution of mass calculations and to identify a tire during operator warnings. The wand device 74 (FIGS. 2 and 22) is used by a tire installer to trigger the tire receiver-transmitter 52 in order that the vehicle data processor 58 can know where each tire is located. The wand 74 comprises a magnet 220 on a stick 222 that emits a magnetic field and, when brought into the proximity of the receiver-transmitter 52, is detected by the magnetic sensor 214 on the receiver-transmitter. The wand 74 is applied when a new tire is mounted on the vehicle, or when the tires are rotated.

The wand 74 is used in coordination with the vehicle data processor 58. Each tire receiver-transmitter transmission triggered by the wand 74 is preceded or followed by an indication, to the vehicle data processor 58, of the respective tire location. This indication is provided through the technician console 72. Alternately, the vehicle data processor 58 can indicate to the installer the location of the tire to be triggered and avoid the technician console 72.

4. The Vehicle Receiver 56

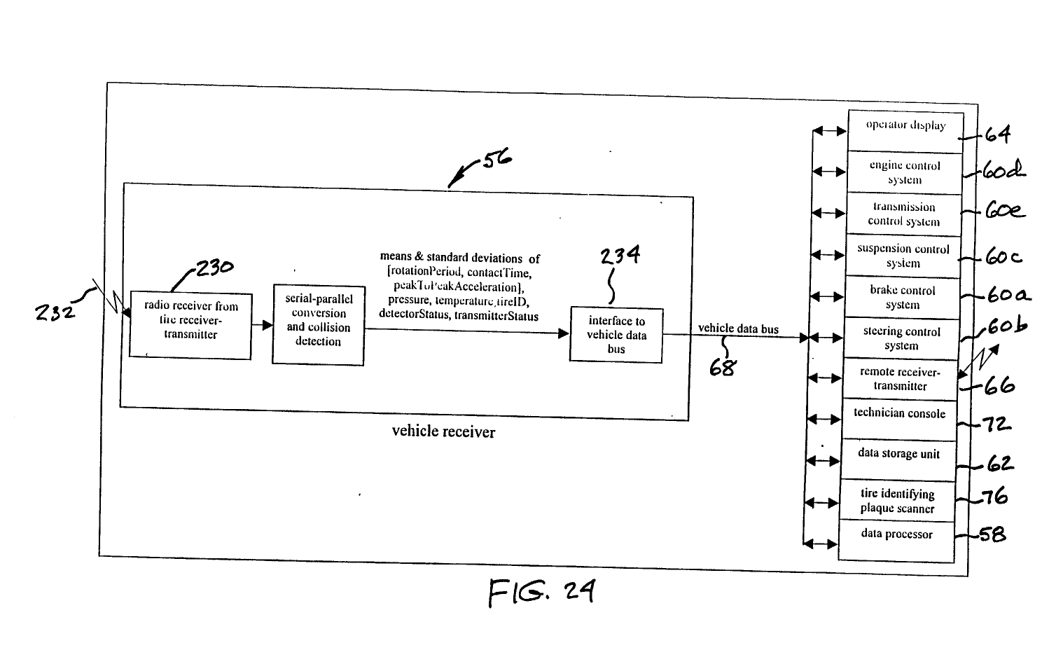

The vehicle receiver 56 (FIGS. 2 and 24) consists of a radio frequency receiver 230, an antenna 232, and an interface 234 to the vehicle data bus 68 through which electrical access is made to the storage memory 62, the processing unit 58, the remote receiver-transmitter 66, the operator display 64, and the vehicle control system 60. Existing tire pressure and temperature reporting systems (Johnson Controls, TRW, Lear, SmarTire, Siemens, etc.) use the same receiver that works with the key transmitters carried by drivers to lock and unlock the doors. Data received by the receiver 56 from the various tires at various times are acquired and stored in the vehicle storage unit 62 for use by the rest of the system.

The vehicle receiver 56:

acquires data from the multiple tire receiver-transmitters and attempts to validate it;

if the data does not validate, it is ignored; and

validated data is stored in the vehicle data storage unit with an indication that it is newly received.

The tire receiver-transmitter data is validated if the start byte is correct and data regenerates the verification check byte.

5. The Vehicle Data Bus 68

Modem vehicles are sophisticated rolling data processing devices with sensors and processors distributed throughout between the brakes, transmission, engine, dashboard, and so forth. As such, vehicles come with built-in data transfer buses for moving information about as needed and comprise wired, wireless, and fiber optic links and their respective communication protocols. The basic concept behind a bus is to provide a standard means whereby a device can be provided with a connection to the bus and, through it, exchange data with any other device so connected. There are standard bus architectures such as the CAN (Controller Area Network) protocol, and many proprietary ones used by the various automobile manufacturers. Accordingly, the data bus 68 (FIGS. 2 and 24) may comprise any of the standard, built-in buses currently in use or as developed in the future.

6. The Vehicle Data Processor 58

Determining Tire Deformation: The flattened and deformed tire is defined by the length of the contact region between the two deflection points. As the tire rotates, its rotation rate (radians/second) is determined from the measured rotationPeriod

$$rotationRate = \frac{2 π}{rotationPeriod}$$

and the contact region is a chord of a circle having a half-angle

$$chordHalfAngle = \frac{rotationRate \times chordTime}{2}$$

where chordTime is the time the tire rolls through the chord. The chord length is given by

$$\begin{matrix}chordLength = 2 tireRadius \times sin ⟨ contactCentralHalfAngle ⟩ \\ = 2 tireRadius \times sin ⟨ \frac{rotationRate \times chordTime}{2} ⟩ \\ = 2 tireRadius \times sin ⟨ \frac{π \times chordTime}{rotationPeriod} ⟩\end{matrix}$$

The chordTime is equal to the measured time between detections of the deflection points, contactTime, plus a bias term (contactBias) related to the width of the base plate 170:

$$\begin{matrix}contactLength = 2 tireRadius \times sin ⟨ \frac{π}{rotationPeriod} ( contactTime + \frac{contactBias \times rotationPeriod}{2 π \times tireRadius} ) ⟩ \\ = 2 tireRadius \times sin ⟨ \frac{π \times contactTime}{rotationPeriod} + \frac{contactBias}{2 tireRadius} ⟩ \\ \approx 2 π \times tireRadius ( \frac{contactTime}{rotationPeriod} ) + contactBias\end{matrix}$$

where the approximation is valid when the contactTime is much less than the rotationalPeriod. Because the time durations are used in a ratio, they do not need to be measured by a precise crystal-controlled timing clock.

Loaded tires can go flat, and a deformation value of interest is the deflation 17 of the tire: how much of its fully inflated radius has been lost by. Deflation is given by:

$$\begin{matrix}deflation = tireRadius \{ 1 - cos ⟨ {sin}^{- 1} ⟨ \frac{contactLength}{2 tireRadius} ⟩ ⟩ \} \\ \approx \frac{{contactLength}^{2}}{8 tireRadius}\end{matrix}$$

The longer this value is, the less tire is left to ride on, and, ultimately, it is equal to (tireRadius−rimRadius) and the tire is completely flat.

The deflection angle 24, the angle between the tangent to the fully inflated tire and the contact region is given by:

$$\begin{matrix}deflectionAngle = \frac{π}{2} - {cos}^{- 1} ⟨ \frac{contactLength}{2 tireRadius} ⟩ \\ \approx \frac{contactLength}{2 tireRadius}\end{matrix}$$

In a fully inflated and unloaded tire this angle is zero; as the tire deflates under load, this angle increases. Since deflectionAngle is the angle 17 the tread bends at each deflection point, it is a measure of tire stress.

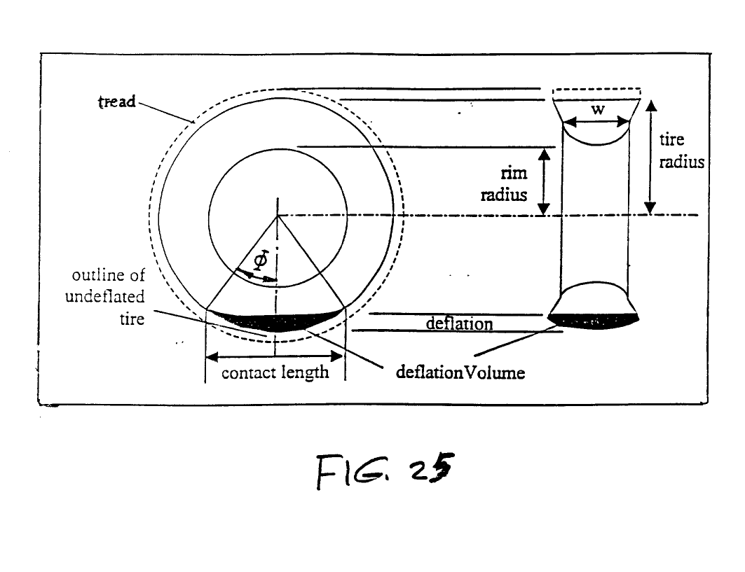

Another value of interest is tire volume. A tire is an annulus, an odd-shaped tire mounted onto a rim. If width of the mounted tire, sidewall to sidewall, is given as a function of the distance from the center of the wheel as w<r>, as shown in FIG. 25, the fully inflated tire has a maximum volume given from elementary Calculus by the integral

$$max Volume = 2 π {\int }_{rimRadius}^{tireRadius} rw ⟨ r ⟩ ⅆ r$$

The relationship w<r> is known to the tire manufacturer. The volume of a partially deflated state as illustrated is given by

volume=maxVolume−deflationVolume

where deflationVolume is the volume lost when the tire is deflated by being loaded. Further applying elementary Calculus, the volume lost due to the flattening (vanishing) of the deflated portion is given by

$$deflationVolume = 2 {\int }_{tireRadius \times cos Φ}^{tireRadius} \{ rw ⟨ r ⟩ {cos}^{- 1} ⟨ \frac{tireRadius \times cos Φ}{r} ⟩ \} ⅆ r$$

where the wheel central angle from the midpoint of the contact region to leading or trailing edge of the contact region is

$$Φ = {sin}^{- 1} ⟨ \frac{contactLength}{2 ( rimRadius + tireRadius )} ⟩$$

This equation for the deflationVolume is a simplification that assumes the ‘flattened’ part of the tire simply disappears and there is no ‘ballooning’ around the contact region. ‘Ballooning’ is accounted for by reducing the deflationVolume by a factor that is determined as a function of the contactLength and is known to the tire manufacturer: kBallooning where

$$\begin{matrix}volume = max Volume - kBallooning ⟨ contactLength ⟩ \times \\ deflationVolume ⟨ contactLength ⟩ \\ = volume ⟨ contactLength ⟩\end{matrix}$$

and the dependence of kBallooning and of deflationVolume on contactLength is shown explicitly.

The maxVolume only needs to be determined once for a tire and is easily integrated by any number of numerical methods (e.g. trapezoidal integration). The deflationVolume is also easily integrated for a given contactLength and can be calculated for several contactLength values and the results tabularized or approximated by simple functions (e.g. an exponential).

Detecting a Tire Puncture from Tire Deformation: Sudden changes in the deflation, deflection angle, or volume are indicative of an abrupt change in tire deformation such as occurs during a tire puncture. Although a tire pressure sensor can detect a blowout by a change in pressure, tire pressure sensors are generally kept turned off and, once turned on, can take several hundred milliseconds to stabilize while accelerometers stabilize within a few milliseconds.

Determining Tire Load: Since force is equal to the pressure applied times the area over which it acts, the tire load is related to the tire pressure, tread width, and tire-road contact length as

$$\begin{matrix}load = α \times treadWidth \times contactLength \times pressure + forceSidewall \\ = α \times treadWidth \times pressure [ 2 tireRadius \times \\ sin ⟨ \frac{π \times contactTime}{rotationPeriod} + \frac{contactBias}{2 tireRadius} ⟩ ] + forceSidewall \\ \approx 2 πα \times treadWidth \times pressure ( tireRadius \frac{contactTime}{rotationPeriod} + \\ contactBias ) + forceSidewall\end{matrix}$$

where treadWidth is the width of the tread, treadWidth×contactLength is the area of applied pressure, forceSidewall is the effective resiliency of the tire sidewall to collapse, contactBias is related to the width of the base plate, and α is a proportionality constant nearly equal to 1. The treadWidth is known from the tire specifications, forceSidewall is known by the tire manufacturer, the tire pressure is measured by a pressure sensor within the tire, and the proportionality constant α and the contactBias are determined as those which best fit laboratory data.

The means and standard deviations of the timing data can be used to calculate the mean and standard deviation of the load estimate. The standard deviation, σ, is given by

$${σ}_{load} \approx 2 πα \times tireRadius \times treadWidth \times pressure \times \frac{\sqrt{{rotationPeriod}_{mean}^{2} {σ}_{contactTime}^{2} + {contactTime}_{mean}^{2} {σ}_{rotationPeriod}^{2}}}{{rotationPeriod}_{mean}^{2}}$$

Determining Tire Molar Air Content: According to the Ideal Gas Law,

pressure×volume=R×moles×temperature

where R is the Universal Gas Constant (8.31451 J/mole/° K.), moles is the number of 6.022×10²³ molecules of gas being considered, volume is the volume within which the molecules are constrained, and pressure and temperature are the pressure within the volume and the temperature of the gas.

In some cases the deflationVolume is insignificant in contrast with the maxVolume and thus

$$moles \approx \frac{max Volume}{R} \frac{pressure}{temperature}$$

otherwise the full relationship needs to be used

$$moles = \frac{volume ⟨ contactLength ⟩}{R} \frac{pressure}{temperature}$$

and, so long as air is not physically added or removed from the tire, this value is constant regardless of pressure or temperature or load. It is the absolute measure of tire inflation and a regular reduction (negative slope) of the molar content indicates an air leak.

The relationship between moles, pressure, temperature, and contactLength, since contactLength is itself a function of load, becomes one between moles, pressure, temperature and load:

$$pressure \times volume ⟨ \frac{load - forceSidewall}{α \times treadWidth \times pressure} ⟩ = R \times moles \times temperature$$

Given any three, the fourth can be calculated.

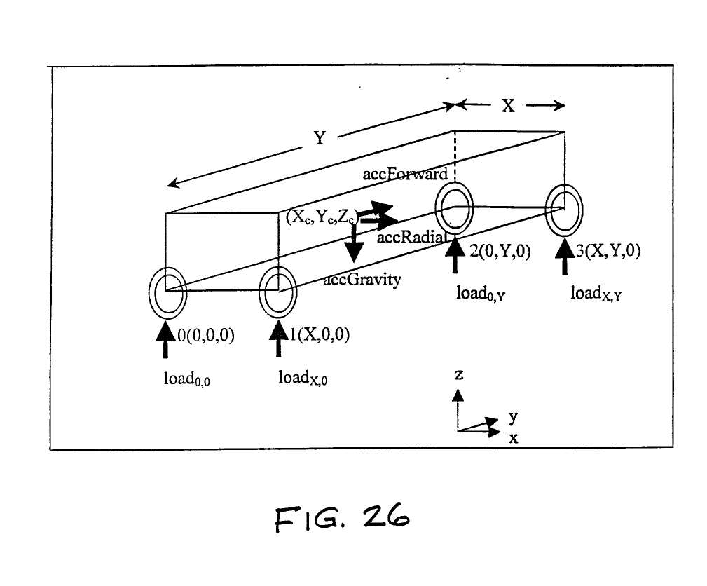

Determining Vehicle Mass and the Distribution of Mass: The distribution of mass is concisely described by the total mass and the location of the center-of-mass. The center-of-mass is the effective point location of the total mass as acted on by all external forces; the forces acting on a four-wheeled moving vehicle are shown in FIG. 26. The reactive forces of the road surface, in the z direction, are equal to the tire loads but opposite in direction, vehicleMass is the vehicle mass, accForward is the net forward (y direction) acceleration of the vehicle due to engine power or gravity on non-level roads, and is entered in its opposite direction to describe its effect on the load; accRadial is the net radial acceleration due to a turn (x direction) and is entered in its opposite direction to describe its centrifugal effect on the load; and accGravity is the acceleration of gravity (−z direction). Imposing zero net torque about each of the vehicle road contact axes:

τ_{0,1}=−vehicleMass×accGravity×Y_{c}+vehicleMass×accForward×Z_{c}+(load_{0,Y}+load_{X,Y})Y≡0

τ_{2,3}=vehicleMass×accGravity(Y−Y_{c})+vehicleMass×accForward×Z_{c}−(load_{0,0}+load_{X,0})Y≡0

τ_{0,2}=vehicleMass×accGravity×X_{c}−vehicleMass×accRadial×Z_{c}−(load_{X,0}+load_{X,Y})X≡0

τ_{1,3}=−vehicleMass×accGravity(X−X_{c})−vehicleMass×accRadial×Z_{c}+(load_{0,0}+load_{0,Y})X≡0

where accForward and accRadial are measured by vehicle accelerometers; accGravity, X, Y, and Z are known; load_{0,0}, load_{0,Y}, load_{X,0}, and load_{X,Y} are the calculated tire loads; and vehicleMass, X_{c}, Y_{c}, and Z_{c} are unknowns to be determined. These four equations can be written in matrix form a

M load−Ax=0

where

$$\begin{matrix}\underline{A} = [ \begin{matrix}0 & 0 & accGravity & - accForward \\ - accGravity ( Y ) & 0 & accGravity & - accForward \\ 0 & - accGravity & 0 & accRadial \\ accGravity ( X ) & - accGravity & 0 & accRadial\end{matrix} ] \\ \underline{M} = [ \begin{matrix}0 & Y & 0 & Y \\ - Y & 0 & - Y & 0 \\ 0 & 0 & - X & - X \\ X & X & 0 & 0\end{matrix} ] , \underline{load} = [ \begin{matrix}{load}_{0 , 0} \\ {load}_{0 , Y} \\ {load}_{X , 0} \\ {load}_{X , Y}\end{matrix} ] , \\ x = [ \begin{matrix}vehicleMass \\ vehicleMass \times {X}_{c} \\ vehicleMass \times {Y}_{c} \\ vehicleMass \times {Z}_{c}\end{matrix} ]\end{matrix}$$

Initially it would seem the solution is the simple matrix inversion

x=A⁻¹M load

with

vehicleMass=x(1)

X_{c}=x(2)/x(1)

Y_{c}=x(3)/x(1)

Z_{c}=x(4)/x(1)

However, the fourth column of A is linearly related to the sum of the second and third columns and the matrix cannot be inverted. The M matrix also cannot be inverted for a similar reason. This means there are less than four independent relationships among the four unknowns.

Algebraically solving the linear coupled equations: there are only three independent relations:

$$vehicleMass = \frac{{load}_{0 , 0} + {load}_{X , 0} + {load}_{0 , Y} + {load}_{X , Y}}{accGravity}$$

$$\begin{matrix}accGravity \times {Y}_{c} - \\ accForward \times {Z}_{c}\end{matrix} = accGravity \frac{{load}_{0 , Y} + {load}_{X , Y}}{\begin{matrix}{load}_{0 , 0} + {load}_{X , 0} + \\ {load}_{0 , Y} + {load}_{X , Y}\end{matrix}} Y$$

$$\begin{matrix}accGravity \times {X}_{c} - \\ accRadial \times {Z}_{c}\end{matrix} = accGravity \frac{{load}_{X , 0} + {load}_{X , Y}}{\begin{matrix}{load}_{0 , 0} + {load}_{X , 0} + \\ {load}_{0 , Y} + {load}_{X , Y}\end{matrix}} X$$

These equations suggest an algorithm to determine the mass and center-of-mass as:

the vehicleMass can always be determined as

$$vehicleMass = \frac{{load}_{0 , 0} + {load}_{X , 0} + {load}_{0 , Y} + {load}_{X , Y}}{accGravity}$$

if there is no accForward, then

$${Y}_{c} = \frac{{load}_{0 , Y} + {load}_{X , Y}}{{load}_{0 , 0} + {load}_{X , 0} + {load}_{0 , Y} + {load}_{X , Y}} Y$$

if there is no accRadial then

$${X}_{c} = \frac{{load}_{X , 0} + {load}_{X , Y}}{{load}_{0 , 0} + {load}_{X , 0} + {load}_{0 , Y} + {load}_{X , Y}} X$$

having determined X_{c} or Y_{c}, Z_{c} is determined once there is either accForward or accRadial:

$${Z}_{c} = \frac{accGravity}{accForward} ( {Y}_{c} - \frac{{load}_{0 , Y} + {load}_{X , Y}}{{load}_{0 , 0} + {load}_{X , 0} + {load}_{0 , Y} + {load}_{X , Y}} Y )$$

$${Z}_{c} = \frac{accGravity}{accRadial} ( {X}_{c} - \frac{{load}_{X , 0} + {load}_{X , Y}}{{load}_{0 , 0} + {load}_{X , 0} + {load}_{0 , Y} + {load}_{X , Y}} X )$$

As information is received from the tires over many observation periods, a simple means to track the center-of-mass in time would be to average the values (weighted equally) using a sliding window averager or a digital low-pass filter. But a better method would be one that weights values with large standard deviations less than those with small ones, and an even better one would optimally weight the values to minimize the standard deviation of the result. The optimal algorithm is referred to as a stochastic state estimator, a Kalman filter, and has the advantage of automatically implementing the above algorithm without having to invert A or M. Given the means and standard deviations of the load estimates, such an algorithm can take full advantage of all the information and automatically adapt to the vehicle accelerations. The result is the real-time optimal estimation of the four constants [vehicleMass, vehicleMass×X_{c}, vehicleMass×Y_{c}, vehicleMass×Z_{c}] and the standard deviations of these estimates.

The Kalman filter is linear in state and measurement:

$$\begin{matrix}{\underline{x}}_{i + 1} = {\underline{x}}_{i} + {\underline{stateNoise}}_{i} \\ {\underline{y}}_{i} = \underline{M} {\underline{load}}_{i} \\ = {\underline{A}}_{i} {\underline{x}}_{i} + {\underline{measurementNoise}}_{i}\end{matrix}$$

where x=[vehicleMass vehicleMass×X_{c} vehicleMass×Y_{c} vehicleMass×Z_{c}]^{T}, and the state noise covariance matrix is selected to trade-off the desired estimate accuracies against the filter ability to track changing values. The filter begins with an initialization phase comprising the following steps and equations:

define vehicle dimensions X, Y

define initial values of vehicleMass₀ and σ_{vehicleMass,0}

define initial values of x center of mass X_{c,0} and σ_{Xc,0}

define initial values of y center of mass Y_{c,0} and σ_{Yc,0}

define initial values of z center of mass Z_{c,0} and σ_{Zc,0}

define state noise σ_{δvehicleMass},σ_{δXc},σ_{δZc}

$$calculate initial state estimate {\underline{x}}_{0 / 0} = [ \begin{matrix}{vehicleMass}_{0} \\ {vehicleMass}_{0} \times {X}_{c , 0} \\ {vehicleMass}_{0} \times {Y}_{c , 0} \\ {vehicleMass}_{0} \times {Z}_{c , 0}\end{matrix} ]$$

$$with covariance$$

$${\underline{x}}_{0 / 0} = {\underline{Λ}}_{0} [ \begin{matrix}{σ}_{vehicleMass , 0}^{2} & 0 & 0 & 0 \\ 0 & {σ}_{δ Xc , 0}^{2} & 0 & 0 \\ 0 & 0 & {σ}_{δ Y , 0}^{2} & 0 \\ 0 & 0 & 0 & {σ}_{δ Z , 0}^{2}\end{matrix} ] {\underline{Λ}}_{0}^{T}$$

$$where {\underline{Λ}}_{0} = [ \begin{matrix}1 & 0 & 0 & 0 \\ {X}_{c , 0} & {vehicleMass}_{0} & 0 & 0 \\ {Y}_{c , 0} & 0 & {vehicleMass}_{0} & 0 \\ {Z}_{c , 0} & 0 & 0 & {vehicleMass}_{0}\end{matrix} ]$$

and each load set is processed according to the following steps and equations:

get measurement mean_{load,0,0,i+1} and σ_{load,0,0,i+1} at tᵢ₊₁

get measurement mean_{load,0,Y,i+1} and σ_{load,0,Y,i+1} at tᵢ₊₁

get measurement mean_{load,X,0,i+1} and σ_{load,X,0,i+1} at tᵢ₊₁

get measurement mean_{load,X,Y,i+1} and σ_{load,X,Y,i+1} at tᵢ₊₁

define the measurement observable:

$${\underline{y}}_{i + 1}^{*} = \underline{M} [ \begin{matrix}{mean}_{load , 0 , 0 , i + 1} \\ {mean}_{load , 0 , Y , i + 1} \\ {mean}_{load , X , 0 , i + 1} \\ {mean}_{load , X , Y , i + 1}\end{matrix} ]$$

$$with covariance$$

$${\underline{Y}}_{i + 1}^{*} = \underline{M} [ \begin{matrix}{σ}_{load , 0 , 0 , i + 1}^{2} & 0 & 0 & 0 \\ 0 & {σ}_{load , 0 , Y , i + 1}^{2} & 0 & 0 \\ 0 & 0 & {σ}_{load , X , 0 , i + 1}^{2} & 0 \\ 0 & 0 & 0 & {σ}_{load , X , Y , i + 1}^{2}\end{matrix} ] {\underline{M}}^{T}$$

$$where \underline{M} ≡ [ \begin{matrix}0 & Y & 0 & Y \\ - Y & 0 & - Y & 0 \\ 0 & 0 & - X & - X \\ X & X & 0 & 0\end{matrix} ]$$

predict the state vector at tᵢ₊₁:

$${\underline{x}}_{i + 1 / i} = {\underline{x}}_{i / i} with covariance {\underline{X}}_{i + 1 / i} = {\underline{X}}_{i / i} + {\underline{δ X}}_{i} \\ where the state noise term is given by$$

$$\underline{δ X} \approx {\underline{Λ}}_{i} [ \begin{matrix}{σ}_{δ vehicleMass}^{2} & 0 & 0 & 0 \\ 0 & {σ}_{δ Xc}^{2} & 0 & 0 \\ 0 & 0 & {σ}_{δ Yc}^{2} & 0 \\ 0 & 0 & 0 & {σ}_{δ Zc}^{2}\end{matrix} ] {\underline{Λ}}_{i}^{T}$$

$$and where$$

$${\underline{Λ}}_{i} = [ \begin{matrix}1 & 0 & 0 & 0 \\ {X}_{c , i / i} & {vehicleMass}_{i / i} & 0 & 0 \\ {Y}_{c , i / i} & 0 & {vehicleMass}_{i / i} & 0 \\ {Z}_{c , i / i} & 0 & 0 & {vehicleMass}_{i / i}\end{matrix} ]$$

predict the observable at tᵢ₊₁:

$$\begin{matrix}{\underline{y}}_{i + 1 / i} = {\underline{A}}_{i + 1} {\underline{x}}_{i + 1 / i} with covariance {\underline{Y}}_{i + 1 / i} \\ = {\underline{A}}_{i + 1} {\underline{X}}_{i + 1 / i} {\underline{A}}_{i + 1}^{T} where \\ {\underline{A}}_{i + 1} = [ \begin{matrix}0 & 0 & accGravity & - {accForward}_{i + 1} \\ - accGravity & 0 & accGravity & - {accForward}_{i + 1} \\ 0 & - accGravity & 0 & {accRadial}_{i + 1} \\ accGravity & - accGravity & 0 & {accRadial}_{i + 1}\end{matrix} ]\end{matrix}$$

calculate the Kalman gain at tᵢ₊₁: Kalman gain matrix

$${\underline{K}}_{i + 1} = {\underline{X}}_{i + 1 / i} {{\underline{A}}_{i + 1}^{T} [ {\underline{Y}}_{i + 1 / i} + {\underline{Y}}_{i + 1}^{*} ]}^{- 1}$$

correct the state at tᵢ₊₁:

$${\underline{x}}_{i + 1 / i + 1} = {\underline{x}}_{i + 1 / i} + {\underline{K}}_{i + 1} ( {\underline{y}}_{i + 1}^{*} - {\underline{y}}_{i + 1 / i} ) with covariance$$

$${\underline{X}}_{i + 1 / i + 1} = ( \underline{I} - {\underline{K}}_{i + 1} {\underline{A}}_{i + 1} ) {\underline{X}}_{i + 1 / i}$$

While the filter is linear, the actual center-of-mass components are non-linearly related to the filter state estimates and are generated according to the following steps and equations:

$$mean output vector {\underline{z}}_{i / i} = [ \begin{matrix}{vehicleMass}_{i / i} \\ {X}_{c , i / i} \\ {Y}_{c , i / i} \\ {Z}_{c , i / i}\end{matrix} ] = [ \begin{matrix}{x ( 1 )}_{i / i} \\ {x ( 2 )}_{i / i} / {x ( 1 )}_{i / i} \\ {x ( 3 )}_{i / i} / {x ( 1 )}_{i / i} \\ {x ( 4 )}_{i / i} / {x ( 1 )}_{i / i}\end{matrix} ]$$

$$with covariance {\underline{Z}}_{i} \approx {\underline{Γ}}_{i / i} {\underline{X}}_{i / i} {\underline{Γ}}_{i / i}^{T} where$$

$${\underline{Γ}}_{i / i} = [ \begin{matrix}1 & 0 & 0 & 0 \\ - {x ( 2 )}_{i / i} / {x ( 1 )}_{i / i}^{2} & 1 / {x ( 1 )}_{i / i} & 0 & 0 \\ - {x ( 3 )}_{i / i} / {x ( 1 )}_{i / i}^{2} & 0 & 1 / {x ( 1 )}_{i / i} & 0 \\ - {x ( 4 )}_{i / i} / {x ( 1 )}_{i / i}^{2} & 0 & 0 & 1 / {x ( 1 )}_{i / i}\end{matrix} ]$$

A similar set of relations can be written for trailers, trucks, and so forth.

Implementation of the Vehicle Data Processor 58: The term “Vehicle Data Processor” is a generic term used herein to describe the various microprocessors, micro-controllers, and other computing devices and their software programs used to satisfy the requirements of this invention. The processors responsible for the vehicle control system operation are considered separate and distributed among its various subsystems. The vehicle data processor 58 (FIG. 2) is responsible for accessing the tire data received by the vehicle receiver 56, data from the vehicle data storage unit 62 and the vehicle control system 60, and for performing the calculations required of this invention.

The vehicle data processor 58:

responds to the indication from the vehicle data storage device that new tire data is available and attempts to verify the message;

reads the tire parameters from data storage: rimRadius, tireRadius, tangentialOffset, α proportionality constant, contactBias, treadWidth, forceSidewall, kBallooning vs. contactLength, deflationVolume vs. contactLength, baseplateWidth, maxPressure, maxDeflation, maxDeflectionAngle, maxTemperature, maxLoad;

reads vehicle parameters from data storage: X and Y vehicle tire positions;

calculates the anticipatedPeakAcceleration is using

$$anticipatedPeakToPeakAcceleration = 4 {π}^{2} \frac{tangentialOffset}{{rotatonPeriod}^{2}}$$

from the reported rotationPeriod and compared to the reported peakToPeakAcceleration;

if the message is valid and the anticipatedPeakToPeakAcceleration compares favorably with the peakToPeakAcceleration:

the means and standard deviations of the instantaneous contactLength and of the load are calculated from the reported means and standard deviations of contactTime and of rotationPeriod based on

$$\begin{matrix}contactLength = 2 tireRadius \times \\ sin ⟨ \frac{π \times contactTime}{rotationPeriod} + \frac{contactBias}{2 tireRadius} ⟩\end{matrix}$$

$$\begin{matrix}load = α \times treadWidth \times pressure [ 2 tireRadius \times \\ sin ⟨ \frac{π \times contactTime}{rotationPeriod} + \frac{contactBias}{2 tireRadius} ⟩ ] + forceSidewall\end{matrix}$$

the accForward and accRadial are acquired from vehicle sensors and the mean and standard deviation of the instantaneous load are processed by the Kalman filter mass and center-of-mass tracking equations based on

$$\begin{matrix}{\underline{x}}_{i + 1} = {\underline{x}}_{i} + {\underline{stateNoise}}_{i} \\ {\underline{M}}_{i} {\underline{load}}_{i} = {\underline{A}}_{i} {\underline{x}}_{i} + {\underline{measurementNoise}}_{i}\end{matrix}$$

the mean and standard deviation of the volume of the tire are determined from the mean and standard deviation of the contactLength based on

$$\begin{matrix}volume = 2 π {\int }_{rimRadius}^{tireRadius} rw ⟨ r ⟩ ⅆ r - 2 kBalooning ⟨ contactLength ⟩ \\ {\int }_{tirRadius \times cos Φ}^{tireRadius} \{ rw ⟨ r ⟩ {cos}^{- 1} ⟨ \frac{tireRadius \times cos Φ}{r} ⟩ \} ⅆ r\end{matrix}$$

the mean and standard deviation of the tire molar content are determined from the mean and standard deviation of the tire volume and the reported tire pressure and temperature based on

$$moles = \frac{volume}{R} \frac{pressure}{temperature}$$

the mean and standard deviation of the tire deflation and deflection angle are determined from the mean and standard deviation of the instantaneous contactLength where deflation and deflection angle are based on

$$\begin{matrix}deflation = tireRadius \{ 1 - cos ⟨ {sin}^{- 1} ⟨ \frac{contactLength}{2 tireRadius} ⟩ ⟩ \} \\ deflectionAngle = \frac{π}{2} - {cos}^{- 1} ⟨ \frac{contactLength}{2 tireRadius} ⟩\end{matrix}$$

vehicle mass and center-of-mass are sent to the vehicle control system; and

tire load, pressure, and moles are evaluated with results sent to the operator display.

The tire pressure required to establish a deflection of deflectionAngleDesired at with a given load is

$$pressure @ deflectionAngleDesired = \frac{load - forceSidewall}{\begin{matrix}2 α \times treadWidth \times \\ tireRadius \times \\ deflectionAngleDesired\end{matrix}}$$

The tire pressure required to establish a deflation of deflationDesired at a given load is

$$pressure @ deflationDesired = \frac{load - forceSidewall}{\begin{matrix}α \times \\ treadWidth \sqrt{\begin{matrix}8 tireRadius \times \\ deflationDesired\end{matrix}}\end{matrix}}$$

The vehicle data processor 58 knows a great deal about each tire:

load

pressure

temperature

molar content

contactLength

deflation

deflection angle

and the manufacturer places limits:

● pressure conditions

| | | |
|---|---|---|
| ◯ pressure | <maxPressure | to limit the internal forces on the |
| | | tire structure |
| ◯ deflation | <maxDeflation | to provide a margin so the tire |
| | | does not bottom out |
| ◯ deflection | <maxDeflectionAngle | to minimize the bending stresses |
| angle | | on the tire structure |
| ● temperature | <maxTemperature | to limit the heating of the tire |
| | | structure |
| ● load | <maxLoad | to limit the internal force on the |
| | | tire structure |

The pressure conditions reduce to the

$$max \{ \begin{matrix}pressure @ max Deflation \\ pressure @ max DeflectionAngle\end{matrix} \} = \begin{matrix}pressureRecommended < \\ max Pressure\end{matrix}$$

If the temperature condition is not met, the operator must stop and cool the tire. If the load and pressure conditions are not met, the operator must alter the load on the tire. If the pressure condition is met, and the tire pressure is not within the proximity of pressureRecommended, the operator must stop and change the tire pressure. If the tire deflation, deflection angle, or volume changes abruptly, the tire has suffered a blowout.

7. The Tire-Identifying Plaque 54 and the Tire-Identifying Plaque Scanner 76

The values of certain tire specific parameters are required by the vehicle data processor 58 in order to perform its duties related to this invention including:

rimRadius, tireRadius, tangentialOffset, contactBias, α proportionality constant, treadWidth, forceSidewall, kBallooning vs. contactLength, deflationVolume vs. contactLength, baseplateWidth, maxPressure, maxDeflation, maxDeflectionAngle, maxTemperature, maxLoad;

and a means is included to facilitate their entry. Each tire carries a tire-identifying plaque 54 (FIG. 2) which contains a series of optical, magnetic or other machine readable data markings, and an identifying plaque scanner 76 (FIGS. 2 and 24) is provided with which to read them. When read, the markings define the values of the various parameters, which are then stored in the vehicle data storage unit 62 for use by the vehicle data processor 58.

The plaque 54 is also marked with a code, readable by humans, which can be entered at the technician console 72 to cause parameter values that are pre-stored in the vehicle data storage unit 62 to be entered for the tire. The plaque and the scanner used when a new tire is mounted on the vehicle.

8. The Vehicle Control System 60

This is a generic term used to describe the various vehicle data processors and subsystems used to control the actuators that move, control and stop the vehicle. The vehicle control system 60 (FIGS. 2 and 24) comprises the brake controller 60a (for example, an anti-lock brake unit), the steering controller 60b, the suspension controller 60c, the engine controller 60d, the transmission controller 60e, and any other controllers and their interactions.

For purposes of the present invention, the vehicle control system 60 is also one that uses the calculated results of this invention to modify the vehicle operation so as to enhance aspects of the vehicle including performance, vehicle stability and safety, and tire safety.

The vehicle brake control system 60a adjusts the braking force on each tire according to the load on the tire. Traction Control, Anti-lock Braking and the Electronic Braking Systems use the mass and mass distribution information to more accurately make the needed adjustments.

The mass, the distribution of mass, and the loads on each tire are used to determine the vehicle stability envelope and to select the maximum perturbation allowed from steering commands. This information is applicable to the steering control system 60b (Electrically Assisted Steering Systems) to limit the yaw rate.

The vehicle suspension control system 60c adjusts the stiffness of the springs for each tire according to the load on the tire. Active Roll Control systems currently use sensed lateral acceleration to increase the hydraulic pressure to move the stabilizer bars in order to remove the body lean when cornering. This same system could also compensate for unequal load distribution.

Given the vehicle mass, the vehicle engine control 60d acts to limit the available torque so as not to exceed the ratings of the drive train; it also uses vehicle mass to diagnose power loss based on sensed acceleration and generated torque; and adjusts the engine power output based on the driven load to increase fuel efficiency.

The vehicle transmission controller 60e adjusts the gear switch points according to vehicle mass in order to maximize fuel efficiency and power.

The mass, the distribution of mass, and the loads on each tire are used to determine the vehicle stability. This information is applicable to the Vehicle Stability Control Systems.

The conditions of the vehicle may indicate that the performance of the vehicle is reduced and the driver should restrict his driving maneuvers. The vehicle control system 60 itself can take action to limit the maximum vehicle speed to maintain stability and not exceed the tire specifications, or to limit steering yaw rate in order to keep rollovers from occurring.

The operator is alerted to the current vehicle control system condition; the actions it has taken on his behalf to safe the vehicle (reducing the maximum attainable speed, steering rate, engine power); and whether he should take further action (change the distribution of mass, restrict driving maneuvers and speed) as needed on a display device 64.

9. The Vehicle Data Storage Unit 62

This is a generic term used to describe the various vehicle data storage locations used to retain parameter and data values as required by this invention. The information includes historical logs of: excessive tire loads, pressures, temperatures; measures of vehicle instability; steps the control system has taken to adapt to the loads; alarms displayed to the operator; and messages exchanged with the remote monitor receiver-transmitter 70 through the vehicle remote receiver transmitter 66.

10. The Vehicle Operator Display 64

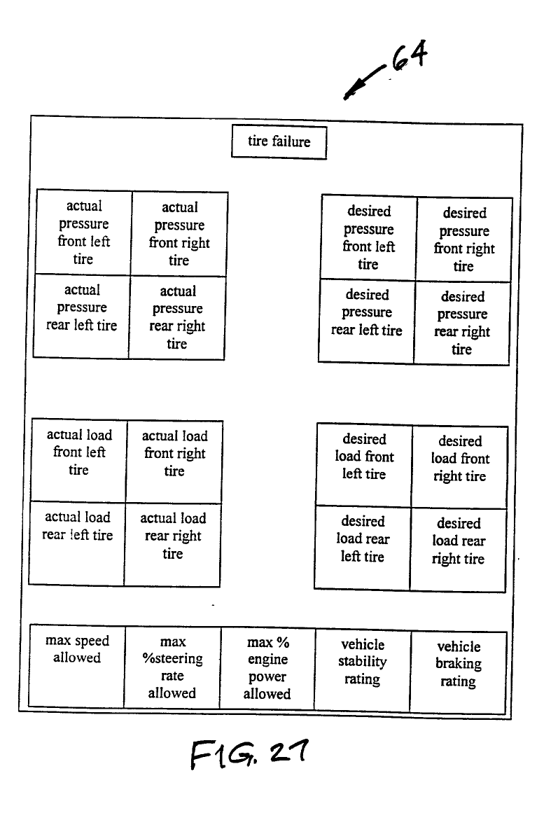

This device comprises a visual or audible unit, for displaying alerts and vehicle status indications in order to inform the operator, and is a standard feature in today's vehicles. An illustration of such a display is presented in FIG. 27.

11. The Vehicle Remote Receiver-Transmitter 66 and The Remote Monitor Receiver-Transmitter 70

The vehicle remote receiver-transmitter 66 comprises a radio frequency receiver-transmitter and antenna used to communicate externally from the vehicle with a remote monitor receiver-transmitter 70 to exchange data between the two. Such remote monitors 70 include a central diagnostic and prognostic facility that checks on the performance and maintenance requirement of the vehicle; governmental or other stations that check the status of passing vehicles (such as a truck weight station to determine the weight of trucks without having them stop and be weighed); police vehicles, and others. Existing vehicle remote receiver-transmitters 66 of this nature are more and more being proposed and implemented in vehicles and use the cellular telephone network and other existing radio frequency links.

As envisioned here, the data provided to the remote monitor receiver-transmitter 70 include: the vehicle mass; the loads on the tires; indications of excessive tire loads, pressures, temperatures; measures of vehicle instability; steps the control system has taken to adapt to the loads; and the alarms displayed to the operator.

12. The Technician Console 72

This device is a generic term used to describe a device used by a maintenance technician to gain access to the vehicle data bus 68 in order to diagnose the vehicle systems and to reprogram their functions. Typically it connects through an electrical port located under the dashboard.

13. Other Embodiments

While several illustrative embodiments of the invention have been shown and described, numerous variations and alternate embodiments will occur to those skilled in the art. For example, instead of high-pass filtering to reduce the effect of gravity, a correction based on the estimated angular orientation of the acceleration contact detector relative to the gravity vector can be subtracted; instead of an optical or RF communications link between the contact region detector and the tire receiver-transmitter, electrical conductors may be used; only the accelerometer may be coupled to the inner tread lining, with electrical conductors being provided to route the accelerometer output signal directly to the in-tire receiver-transmitter which would incorporate all of the circuitry and functions otherwise distributed between the contact region detector and the in-tire receiver-transmitter; the accelerometer and any support electronics can be embedded within a tire wall rather than be mounted on an inner surface; the contact region detector and the tire receiver-transmitter may be integrated into a single unit mounted on the inner tread lining; instead of being connected to the technician console, the tire identifying plaque scanner may be coupled directly to the vehicle data bus; the tire identifying plaque scanner and the wand may be combined into a single unit; instead of a magnetic energy source in the wand, sonic or radio frequency energy may be employed; instead of optical encoding, the tire identifying plaque and the associated tire identifying plaque scanner can use magnetic encoding; and instead of a battery, another power source can be used. Such variations and alternate embodiments, as well as others, are contemplated, and can be made without departing from the spirit and scope of the invention as defined in the appended claims.

What is claimed is:

1. A device for determining the occurrences of deflections of a vehicle tire due to a load while rotating upon a load-bearing surface, the device comprising:
an accelerometer, adapted to be mounted on the tire, for sensing acceleration variations due to load-induced tire deflections and providing an output representative of said acceleration variations; and
an electrical circuit responsive to said output to provide signals representative of the occurrences of said deflections.

2. The device of claim 1 in which:
the accelerometer is adapted to be mounted on an inner surface of the tire.

3. The device of claim 1 in which:
the accelerometer is adapted to be mounted on an inner tread lining of the tire.

4. The device of claim 1 in which:
the accelerometer is adapted to be embedded within a wall of the tire.

5. The device of claim 1 in which:
the accelerometer is adapted to be positioned to sense acceleration variations along a radius of the tire.

6. The device of claim 1 in which:
the accelerometer is adapted to be positioned to sense acceleration variations perpendicular to a radius of the tire.

7. The device of claim 1 which further comprises:
a base plate attached to the accelerometer.

8. The device of claim 7 which further comprises:
an adhesive patch operatively associated with said base plate for attaching the accelerometer to an inner surface of the tire.

9. The device of claim 1 which further comprises:
a fastener for attaching the accelerometer to the tire.

10. A device, adapted to be mounted on a vehicle tire, for determining the occurrences of deflections of the tire due to a load while rotating upon a load bearing surface, the device comprising:
a substrate;
an accelerometer mounted on the substrate for sensing acceleration variations due to load induced tire deflections and providing an output representative of said acceleration variations; and
an electrical circuit mounted on the substrate, said circuit being responsive to said accelerometer output to provide signals representative of the occurrences of said deflections.

11. The device of claim 10 in which:
the substrate is adapted to be mounted on an inner surface of the tire.

12. The device of claim 10 in which:
the substrate is adapted to be mounted on an inner tread lining of the tire.

13. The device of claim 10 in which:
the substrate is adapted to be embedded in a wall of the tire.

14. The device of claim 10 in which:
the accelerometer is adapted to be positioned to sense acceleration variations along a radius of the tire.

15. The device of claim 10 in which:
the accelerometer is adapted to be positioned to sense acceleration variations perpendicular to a radius of the tire.

16. The device of claim 10 in which the device further comprises:
a base plate attached to the substrate for attaching the device to the inner surface of the tire.

17. The device of claim 16 which further comprises:
an adhesive patch operatively associated with said base plate for attaching the device to said inner surface of the tire.

18. The device of claim 10 in which the device further comprises:
a fastener attached to the substrate for attaching the device to said inner surface of the tire.

19. The device of claim 10 in which:
said electrical circuit includes a data processor; and
in which the device further comprises:
an electrical power supply mounted on the substrate, the power supply being connected to power the electrical circuit.

20. The device of claim 19 in which the device further comprises:
a transmitter mounted on the substrate for transmitting to a remote location information based on said signals.

21. The device of claim 20 in which the device further comprises:
a receiver mounted on the substrate for receiving data from said remote location.

22. In a tire adapted to be mounted on a vehicle wheel, a device for determining the occurrences of deflections of the tire due to a load while rotating upon a load-bearing surface, the device comprising:
an accelerometer mounted on the tire, the accelerometer being disposed to sense acceleration variations due to load-induced tire deflections and adapted to provide an output representative of said acceleration variations.

23. The device of claim 22 in which:
the accelerometer is oriented to sense acceleration variations along a radius of the tire.

24. The device of claim 22 in which:
the accelerometer is oriented to sense acceleration variations perpendicular to a radius of the tire.

25. The device of claim 22 in which:
the accelerometer is mounted on an inner surface of the tire.

26. The device of claim 25 in which:
the inner surface comprises an inner tread lining of the tire.

27. The device of claim 22 in which:
the accelerometer is embedded in a wall of the tire.

28. In a tire adapted to be mounted on a vehicle wheel, a device for determining the occurrences of deflections of the tire due to a load while rotating upon a load-bearing surface, the device comprising:
a substrate attached to the tire at a selected radial and circumferential location;
an accelerometer mounted on the substrate, the accelerometer being disposed to respond to acceleration variations in load-induced tire deflections and being adapted to provide an output representative of said acceleration variations; and
an electrical circuit mounted on the substrate, said circuit being responsive to said accelerometer output to provide signals representative of the occurrences of said deflections.

29. The device of claim 28 in which:
the accelerometer is disposed to sense acceleration variations along a radius of the tire.

30. The device of claim 28 in which:
the accelerometer is disposed to sense acceleration variations perpendicular to a radius of the tire.

31. The device of claim 28 in which:
the accelerometer is mounted on an inner surface of the tire.

32. The device of claim 28 which further comprises:
a base plate, the substrate being secured to the base plate, the substrate being attached to the tire by means of said base plate.

33. The device of claim 32 in which:
the base plate has opposed, parallel inner and outer surfaces, the outer surface engaging an inner surface of the tire, the base plate having a periphery; and
in which the device further comprises:
a patch overlying the inner surface of base plate, the base plate being sandwiched between the patch and the inner surface of the tire, the patch having a portion extending beyond the periphery of the base plate, said portion of said patch being bonded to the inner surface of the tire.

34. The device of claim 33 in which:
the patch includes an aperture through which the substrate projects.

35. The device of claim 32 in which:
the substrate is detachably secured to the base plate.

36. The device of claim 28 in which:
the substrate is attached to the tire by means of a fastener.

37. The device of claim 36 in which:
said fastener includes a post anchored in a wall of the tire.

38. The device of claim 28 in which:
said electrical circuit includes a data processor; and
in which the device further comprises:
an electrical power supply for powering the electrical circuit.

39. The device of claim 28 further comprising:
a transmitter mounted on the substrate for transmitting to a remote location information based on said accelerometer output signals.

40. The device of claim 39 further comprising:
a receiver mounted on the substrate for receiving data from said remote location.

41. A device for determining the occurrences of deflections of a vehicle tire due to a load on the tire while rotating upon a load-bearing surface, the device comprising:
means, adapted to be mounted on the tire relative to an inner surface thereof, for sensing acceleration variations in response to load-induced tire deflections and for providing an output representative of said acceleration variations; and
means responsive to said output for providing signals representative of the occurrences of said tire deflections.

42. In a vehicle wheel comprising a tire mounted on a wheel rim, the tire having known geometric parameters, the tire and rim defining a cavity for retaining air under pressure, an apparatus within said cavity for monitoring the load-induced deformation imposed on the tire during rotation thereof on a load-bearing surface, said apparatus comprising:
a. a device attached to the tire for determining the occurrences of deflections of the tire due to a load on the tire while rotating upon the load bearing surface, the device comprising:
(1) an accelerometer disposed to sense acceleration variations due to load-induced tire deflections and being adapted to provide an output representative of said acceleration variations;
(2) an electrical circuit responsive to said accelerometer output to provide signals representative of the occurrences of said tire deflections; and
(3) a transmitter coupled to said electrical circuit and adapted to transmit signals representative of said tire deflection signals; and
b. a receiver positioned to receive said signals transmitted by said transmitter.

43. The apparatus of claim 42 further comprising:
a processor responsive to said received signals, for determining the tire deformation based on said received signals and the known geometric parameters of the tire.

44. The apparatus of claim 42 in which:
the tire deformation is selected from the group consisting of the length of the load-bearing surface contact; the deflection angle of the tire relative to the load-bearing surface contact; the deflation of the tire; the volume of the tire; and the deflation volume of the tire.

45. The apparatus of claim 42 further comprising:
a communications link for coupling the transmitter and the receiver.

46. The apparatus of claim 45 in which:
the communications link is an optical link.

47. The apparatus of claim 45 in which:
the communications link is an RF link.

48. The apparatus of claim 42 in which:
the vehicle wheel includes a valve stem communicating with the cavity defined by the tire and wheel rim, the valve stem including an inner portion projecting into said cavity; and
the transmitter is mounted on said inner portion of the valve stem.

49. The apparatus of claim 42 further comprising:
an air pressure sensor, a second transmitter and a second electrical circuit coupling the receiver, the pressure sensor and the second transmitter, the second transmitter being adapted to transmit tire deflection signals and signals representative of the air pressure, to a location remote from the vehicle wheel.

50. The apparatus of claim 42 in which:
the accelerometer is disposed to sense acceleration variations along a radius of the tire.

51. The apparatus of claim 42 in which:
the accelerometer is disposed to sense acceleration variations perpendicular to a radius of the tire.

52. The apparatus of claim 42 further comprising:
a base plate, the device being attached to the tire by means of the base plate.

53. The apparatus of claim 52 in which:
the base plate has opposed, parallel inner and outer surfaces, the outer surface engaging an inner surface of the tire, the base plate having a periphery; and
in which the apparatus further comprises:
a patch overlying the inner surface of the base plate, the base plate being sandwiched between the patch and the inner surface of the tire, the patch having a portion extending beyond the periphery of the base plate, said portion of said patch being bonded to the inner surface of the tire.

54. The apparatus of claim 53 in which:
the patch includes an opening through which the device projects.

55. The apparatus of claim 42 further comprising:
a fastener for attaching the device to the tire.

56. The apparatus of claim 55 in which:
the fastener is adapted to releasably attach the device to the tire.

57. In a vehicle wheel comprising a tire mounted on a wheel rim, the tire and rim defining a cavity for retaining air under pressure, an apparatus for monitoring the load imposed on the tire during rotation thereof on a load-bearing surface, said apparatus comprising:
an accelerometer disposed to sense acceleration variations due to load induced tire deflections and for providing an output representative of said acceleration variations;
a first electrical circuit responsive to said accelerometer output to provide signals representative of the occurrences of said tire deflections;
a pressure sensor disposed to sense the pressure of the air within the cavity and provide an output representative of said pressure;
a second electrical circuit responsive to said pressure sensor output to provide signals representative of said air pressure; and
a transmitter coupled to said first and second electrical circuits and adapted to transmit signals representative of said tire deflection and pressure signals;

58. In a vehicle wheel comprising a tire mounted on a wheel rim, the tire and rim defining a cavity for retaining air under pressure, an apparatus for monitoring the molar quantity of air within the tire during rotation thereof on a load-bearing surface, said apparatus comprising:
an accelerometer disposed to sense acceleration variations due to load induced tire deflections and for providing an output representative of said acceleration variations;
a first electrical circuit responsive to said accelerometer output to provide signals representative of the occurrences of said tire deflections;
a pressure sensor disposed to sense the pressure of the air within the cavity and to provide an output representative of said pressure;
a second electrical circuit responsive to said pressure sensor output to provide signals representative of said air pressure;
a temperature sensor disposed to sense the temperature of the air within the cavity and to provide an output representative of said temperature;
a third electrical circuit responsive to said temperature sensor output to provide signals representative of said air temperature; and
a transmitter coupled to said first, second and third electrical circuits and adapted to transmit signals representative of said tire deflection and air pressure and temperature signals.

59. An apparatus for monitoring a load induced deformation imposed on a tire during rotation thereof on a load-bearing surface, the tire having known geometric parameters, said apparatus comprising:
means, attached to a localized region within the tire, for sensing the acceleration of said localized region in response to variations in load-induced tire deflections, and for providing an output representative of said acceleration;
means responsive to said acceleration-representative output for transmitting signals representative of the occurrences of said tire deflections;
means for receiving said transmitted signals; and
means for computing the tire deformation using the received signals and the known geometric parameters of the tire.

60. An apparatus for monitoring the load imposed on a tire during rotation thereof on a load-bearing surface, the tire having known geometric parameters, the tire being mounted on a wheel rim, the tire and rim defining a cavity for retaining air under pressure, said apparatus comprising:
means, attached to a localized region within the tire, for sensing the acceleration of said localized region due to load-induced tire deflections, and for providing an output representative of said acceleration;
means for sensing the air pressure within said cavity and for providing an output representative of said pressure;
means responsive to said acceleration-representative output and said pressure-representative output for transmitting signals representative of said pressure and the occurrences of said tire deflections;
means for receiving said transmitted signals; and
means for computing the tire load based on received signals and the known geometric parameters of the tire.

61. An apparatus for monitoring the molar quantity of air within a tire during rotation thereof on a load-bearing surface, the tire having known geometric parameters, the tire being mounted on a wheel rim, the tire and rim defining a cavity for retaining air under pressure, said apparatus comprising:
means, attached to a localized region within the tire, for sensing the acceleration of said localized region due to load-induced tire deflections, and for providing an output representative of said acceleration;
means for sensing the air pressure within said tire and for providing an output representative of said pressure;
means for sensing the air temperature within said tire and for providing an output representative of said temperature;
means responsive to said acceleration-representative output, said pressure-representative output and said temperature-representative output for transmitting signals representative of said pressure and said temperature and of the occurrences of said tire deflections;
means for receiving said transmitted signals; and
means for computing the tire molar air content based on the received signals and the known geometric parameters of the tire.

62. In a vehicle wheel comprising a tire mounted on a wheel rim, the tire having known geometric parameters, the tire and rim defining a cavity for retaining air under pressure, an apparatus for monitoring the load-induced deformation imposed on the tire during rotation thereof on a load-bearing surface, said apparatus comprising:
an accelerometer attached to a wall of the tire, the accelerometer being disposed to sense acceleration variations due to load-induced tire deflections and being adapted to provide an output representative of said acceleration variations;
an electrical circuit responsive to said accelerometer output to provide signals representative of the occurrences of said tire deflections; and
a transmitter coupled to said electrical circuit, said transmitter being adapted to transmit signals representative of said tire deflection signals.

63. The apparatus of claim 62 in which:
the accelerometer, electrical circuit and transmitter are integrated into a single unit.

64. The apparatus of claim 63 in which:
said single unit is releasably attached to said tire wall.

65. The apparatus of claim 63 in which:
said single unit is embedded in said tire wall.

66. The apparatus of claim 63 further comprising:
a patch for securing the single unit to a wall of the tire.

67. The apparatus of claim 63 further comprising:
a fastener for securing the single unit to a wall of the tire.

68. The apparatus of claim 67 in which:
said fastener releasably secures the unit to the tire wall.

69. The apparatus of claim 62 further comprising:
a receiver positioned to receive said tire deflection signals transmitted by said transmitter.

70. The apparatus of claim 69 further comprising:
a communications link for coupling the transmitter and the receiver.

71. The apparatus of claim 70 in which:
the communications link is an optical link.

72. The apparatus of claim 70 in which:
the communications link is an RF link.

73. The apparatus of claim 62 further comprising:
a second transmitter, the second transmitter being coupled to said receiver and adapted to transmit said tire deflection signals to a location remote from the vehicle wheel.

74. The apparatus of claim 62 in which:
the accelerometer is disposed to sense acceleration variations along a radius of the tire.

75. The apparatus of claim 62 in which:
the accelerometer is disposed to sense acceleration variations perpendicular to a radius of the tire.

76. A method for determining the occurrence of a deflection of a vehicle tire due to a load on the tire while rotating on a load bearing surface, the method comprising the steps of:
sensing acceleration in a local region of the tire;
detecting an acceleration variation caused by the load induced deflection of the tire; and
generating a signal in response to the detected acceleration variation, said signal indicating the occurrence of the deflection.

77. The method of claim 76 further comprising the step of:
correcting said signal for the effect of gravity.

78. The method of claim 77 in which:
said correcting step is performed by correcting for an estimated gravitational term.

79. The method of claim 78 in which said correcting step comprises the steps of:
establishing a rotational index reference;
determining the tire rotational position relative to the index; and
determining the gravitational term based on the tire rotational position.

80. The method of claim 79 in which the correcting step further comprises the step of:
inhibiting the frequency band in which the effect of gravity is expressed.

81. The method of claim 76 further comprising the step of:
correcting said signal for the effect of road noise.

82. The method of claim 81 in which:
the effect of road noise is corrected by inhibiting the frequency band in which said road noise is expressed.

83. A method for determining the occurrence of a deflection of a vehicle tire due to a load on the tire while rotating on a load bearing surface comprising the steps of:
sensing acceleration in a local region of the tire;
generating a first signal representative of the sensed acceleration;
comparing the first signal with a second signal representative of a reference acceleration; and
generating a third signal indicating the occurrence of the deflection in response to the comparison of the first and second signals.

84. The method of claim 83 further comprising the step of:
correcting for the effect of gravity.

85. The method of claim 84 in which:
said correcting step is performed by correcting for an estimated gravitational term.

86. The method of claim 85 in which said correcting step comprises the steps of:
establishing a rotational index reference;
determining the tire rotational position relative to the index; and
determining the gravitational term based on the tire rotational position.

87. The method of claim 86 in which the correcting step further comprises the step of:
inhibiting the frequency band in which the effect of gravity is expressed.

88. The method of claim 83 further comprising the step of:
correcting for the effect of road noise.

89. The method of claim 88 in which:
the effect of road noise is corrected by inhibiting the frequency band in which said road noise is expressed.

90. A method for determining the deformation of a loaded vehicle tire mounted on a rim, the tire having a contact region between the tire and a load-bearing surface, the contact region being delimited by a leading edge and a trailing edge, the tire having known geometric parameters, the tire and rim defining an interior tire cavity, the method comprising the steps of:
sensing acceleration in a local region of the tire;
detecting the occurrences of a first acceleration variation and a second acceleration variation occurring, respectively, at said leading and trailing edges of the contact region;
determining the elapsed time between the occurrences of said first and second acceleration variations;
determining the rotational period of the tire based on the time between the occurrences of sequential acceleration variations at said leading edge or at said trailing edge; and
computing the tire deformation based on the ratio of said elapsed time to said rotational period and the known geometric parameters of the tire.

91. The method of claim 90 in which:
the deformation is selected from the group consisting of the length of the contact region; the tire deflation; the tire deflation volume; the tire volume; and the tire deflection angle.

92. A method for determining the molar air content of a loaded vehicle tire mounted on a rim, the tire having a contact region between the tire and a load-bearing surface, the contact region being delimited by a leading edge and a trailing edge, the tire having known geometric parameters, the tire and rim defining an interior tire cavity, the method comprising the steps of:
measuring the pressure and the temperature of the air within the tire cavity;
generating signals representative of said measured air pressure and temperature;
sensing acceleration in a local region of the tire;
detecting the occurrences of a first acceleration variation and a second acceleration variation occurring, respectively, at said leading and trailing edges of the contact region;
determining the elapsed time between the occurrences of said first and second acceleration variations and generating a signal representative of said elapsed time;
determining the rotational period of the tire based on the time between the occurrences of sequential acceleration variations at said leading edge or at said trailing edge; and
computing the molar air content of the loaded tire based on said signals and the known geometric parameters of the tire.

93. A method for determining the leakage of molar air content from a loaded vehicle tire mounted on a rim, the tire having a contact region between the tire and a load-bearing surface, the contact region being delimited by a leading edge and a trailing edge, the tire having known geometric parameters, the tire and rim defining an interior tire cavity, the method comprising the steps of:
measuring the pressure and the temperature of the air within the tire cavity;
generating signals representative of said measured air pressure and temperature;
sensing acceleration in a local region of the tire;
detecting the occurrences of a first acceleration variation and a second acceleration variation occurring, respectively, at said leading and trailing edges of the contact region;
determining the elapsed time between the occurrences of said first and second acceleration variations and generating a signal representative of said elapsed time;
determining the rotational period of the tire based on the time between the occurrences of sequential acceleration variations at said leading edge or at said trailing edge; and
computing the molar air content of the loaded tire based on the said signals and the known geometric parameters of the tire; and
determining that the rate of change of the molar air content is negative.

94. A method for determining the load on a loaded vehicle tire mounted on a rim, the tire and rim defining an interior tire cavity, the tire having a contact region between the tire and a load-bearing surface, the contact region being delimited by a leading edge and a trailing edge, the tire having known geometric parameters, said method comprising the steps of:
measuring the pressure of the air within the tire cavity;
generating a signal representative of said measured air pressure;
sensing acceleration in a local region of the tire;
detecting the occurrences of a first acceleration variation and a second acceleration variation occurring, respectively, at said leading and trailing edges of the contact region;
determining the elapsed time between the occurrences of said first and second acceleration variations and generating a signal representative of said elapsed time;
determining the rotational period of the tire based on the time between the occurrences of sequential acceleration variations at said leading edge or at said trailing edge; and
computing the load on the loaded tire based on the known geometric parameters of the tire and said signals.

95. A method for determining the total mass of a vehicle supported by a plurality of wheels, each of the wheels comprising a tire mounted on a rim, the tire and rim of each wheel defining an interior tire cavity, each tire having a contact region between the tire and a load-bearing surface, the contact region being delimited by a leading edge and a trailing edge, each tire having known geometric parameters, said method comprising the steps of:
a. for each tire:
(1) measuring the pressure of the air within the tire cavity;
(2) generating a signal representative of said measured air pressure;
(3) sensing acceleration in a local region of the tire;
(4) detecting the occurrences of a first acceleration variation and a second acceleration variation occurring, respectively, at said leading and trailing edges of the contact region;
(5) determining the elapsed time between the occurrences of said first and second acceleration variations and generating a signal representative of said elapsed time; and
(6) determining the rotational period of the tire based on the time between the occurrences of sequential acceleration variations at said leading edge or at said trailing edge; and
b. computing the total mass of the vehicle based on said signals from each of the plurality of tires and their known geometric parameters.

96. A method for determining the distribution of mass of a vehicle supported by a plurality of wheels, each of the wheels comprising a tire mounted on a rim, the tire and rim of each wheel defining an interior tire cavity, each tire having a contact region between the tire and a load-bearing surface, the contact region being delimited by a leading edge and a trailing edge, each tire having known geometric parameters and position on the vehicle, said method comprising the steps of:
a. for each tire:
(1) measuring the pressure of the air within the tire cavity;
(2) generating a signal representative of said measured air pressure;
(3) sensing acceleration in a local region of the tire;
(4) detecting the occurrences of a first acceleration variation and a second acceleration variation occurring, respectively, at said leading and trailing edges of the deflection;
(5) determining the elapsed time between the occurrences of said first and second acceleration variations and generating a signal representative of said elapsed time; and
(6) determining the rotational period of the tire based on the time between the occurrences of sequential acceleration variations at said leading edge or at said trailing edge; and
b. computing the distribution of mass of the vehicle based on said signals and the known geometric parameters and positions of each of the plurality of tires.

97. The method of claim 96 further including the step of:
determining at least one vehicle motion parameter and generating a signal representative of said motion parameter;
and in which:
the computing step is additionally based on the signal representative of said motion parameter.

98. The method of claim 96 in which:
the distribution of mass is the two-dimensional center of mass of the vehicle.

99. The method of claim 96 further including the step of:
determining at least one vehicle motion parameter and generating a signal representative of said motion parameter;
and in which:
the computing step is additionally based on the signal representative of said motion parameter and the distribution of mass is the three-dimensional center of mass of the vehicle.

100. The method of claim 96 further including the steps of:
a. for each tire:
(1) determining a plurality of elapsed times and rotational periods over a series of tire rotations; and
(2) determining the nominal values of the plurality of elapsed times and of rotational periods and their variablility about their nominal values and generating signals representative of said nominal values and variability;
b. computing the nominal value and the variability about the nominal value of the distribution of mass of the vehicle based on said signals and the known geometric parameters and positions of each of the plurality of tires.

101. A system for monitoring in real time the load-induced deflection on at least one tire supporting a vehicle and for providing deflection-related information, the at least one tire being mounted on a rim and defining with said rim an interior tire cavity, the at least one tire having a contact region between the at least one tire and a load-bearing surface, the at least one tire having known parameter values, the at least one tire having an on-contact time and a rotational period, said system comprising:
an accelerometer disposed within the at least one tire to sense acceleration variations due to load induced tire deflections and for providing an output representative of said acceleration variations;
an electrical circuit responsive to said accelerometer output for producing signals from which the ratio of the on-contact time to the rotational period of the at least one tire may be determined;
a transmitter mounted within the tire cavity responsive to said ratio-determining signals, for transmitting a signal representative thereof to a location within said vehicle remote from the at least one tire;
a receiver within the vehicle remote from the at least one tire for receiving said signals transmitted by the transmitter mounted within the tire cavity;
a memory for storing known values comprising parameter values of the at least one tire; and
a computer connected to said receiver and memory for computing said deflection-related information based on said transmitted signal and said known tire parameter values.

102. The system of claim 101 which further includes:
a remote receiver-transmitter carried by the vehicle and coupled to the computer for receiving said deflection-related information and for transmitting said information to a monitor remote from said vehicle; and
a receiver remote from the vehicle for receiving said load-related information from the vehicle.

103. The system of claim 101 in which the at least one tire includes an exterior surface and which further includes:
machine-readable indicia on the exterior surface of the at least one tire, said indicia identifying at least one parameter value affecting the determination of tire deflection-related information.

104. The system of claim 103 which includes:
a scanner for reading said machine-readable parameter indicia, and connected to store the at least one identified parameter value into said memory.

105. The system of claim 101 which further comprises:
a display at an operator's station within the vehicle, said display being connected to said computer for displaying said deflection-related information.

106. The system of claim 101 in which:
the computer is coupled to at least one adaptive vehicle control system responsive to said deflection-related information, said at least one adaptive vehicle control system being associated with at least one of the following: an engine, a transmission, a steering system, a brake system, and a suspension system.

107. The system of claim 101 in which:
the memory is adapted to store vehicle related parameters; and in which:
said computer is adapted to compute said deflection-related information based also on said vehicle related parameters.

108. The system of claim 101 in which:
the deflection-related information is selected from the group consisting of the length of the load-bearing surface contact; the deflection angle of the tire relative to the load-bearing surface contact; the deflation of the tire; the volume of the tire; and the deflation volume of the tire.

109. The system of claim 101 which further includes:
a pressure sensor mounted within the tire cavity for sensing the pressure of the air within the cavity and generating a signal representative of said pressure; and
said computer is adapted to compute said deflection-related information based also on said pressure signal.

110. The system of claim 109 where the deflection-related information is the tire load.

111. The system of claim 109 in which:
the system monitors the deflection on each of a plurality of loaded tires supporting the vehicle; and
the deflection-related information is selected from the group consisting of total vehicle mass, vehicle mass distribution and the location of the center of mass of the vehicle.

112. The system of claim 109 further including:
a. within each tire:
(1) a temperature sensor mounted within the tire cavity for sensing the temperature of the air within the cavity and generating a signal representative of said temperature; and
(2) the transmitter within the tire and the receiver within the vehicle being also responsive to said temperature signal for transmitting and receiving signals representative thereof;
b. the memory is furthermore adapted to store known parameter values affecting the determination of tire molar content; and
c. the computer is furthermore adapted to compute tire molar content related information.

113. The system of claim 101 in which:
a. the electrical circuit responsive to said accelerometer output is further adapted to:
(1) determine multiple samples of values from which said ratio can be determined; and
(2) reduce the samples to signals that represent, of the samples, the nominal values and the variation about the nominal; and in which
b. the transmitter within the tire and the receiver within the vehicle being also responsive to said nominal and variation signals; and
c. said computer is further adapted to compute said deflection-related information based on said nominal and variation signals.

114. A vehicle tire including a sidewall having an exterior surface, the tire comprising:
machine-readable information disposed on the exterior surface of the tire sidewall within a local region of said surface, the information identifying at least one parameter value relating to the determination of the load-induced deformation capability of the tire.

115. The tire of claim 114 in which:
the parameter value is identified by providing its numeric value.

116. The tire of claim 114 in which:
the information is readable magnetically.

117. The tire of claim 114 in which:
the information is readable optically.

118. The tire of claim 114 which further comprises:
a plaque mounted on the exterior surface of the tire within said local region thereof, the plaque having an outer surface carrying said machine-readable information.

119. An electronic package adapted to be attached to an inner surface of a vehicle tire, the package comprising:
a base plate attached to said package; and
an adhesive patch, operatively associated with said base plate, for attaching the package to said inner surface of the tire.

120. The package of claim 119 in which:
the base plate comprises parallel inner and outer surfaces and a periphery, the outer surface of the base plate being adapted to engage the inner surface of the tire, the patch overlying the inner surface of the base plate, the base plate being thereby adapted to be sandwiched between the patch and said inner surface of the tire; and
the patch having a portion extending beyond the periphery of the base plate, said portion of the patch being adapted to be bonded to said inner surface of the tire.

121. The device of claim 120 for which:
the patch includes an opening through which the package projects.

122. A vehicle tire having a wall, an inner surface and an interior cavity, the tire comprising:
an electronic package;
a post anchored in the wall of the tire and having an end projecting from said inner surface into the interior cavity of the tire; and
a fastener coupling the electronic package to the projecting end of the post.

123. The vehicle tire of claim 122 in which:
the fastener releasably couples the electronic package to the post, the package being thereby removable from said post and transferable to another vehicle tire equipped with a post.
